(19) United States
(12) Patent Application Publication
(10) Pub. No.: US 2011/0287953 A1
(43) Pub. Date: Nov. 24, 2011

(54) METHOD FOR DISCOVERING POTENTIAL DRUGS

(76) Inventors: Chi-Ying Huang, Taipei City (TW); Ming-Ying Lan, Taipei City (TW); Ming-Huang Chen, Taipei City (TW)

(21) Appl. No.: 13/113,679

(22) Filed: May 23, 2011

Related U.S. Application Data
(60) Provisional application No. 61/347,371, filed on May 21, 2010.

(51) Int. Cl. C40B 30/02

(52) U.S. Cl. 506/8

(57) ABSTRACT

The preset invention relates to a process for discovering potential treatment strategy for a given disease, providing a niche for PPI network construction, target prioritization, and potential drug identification for a given disease, particular a cancer, based on the interaction between prioritized NPC targets (e.g. cliques and bottleneck genes) and drugs.

### FIELD OF THE INVENTION

The present invention relates to a process for discovering potential drugs for treating a given disease by identifying a therapeutic target as a potential treatment strategy.

### BACKGROUND OF THE INVENTION

Bioinformatics refers to a study of informatics process in biotic systems, which is applied in the creation and maintenance of a database to store biological information at the beginning of the “genomic revolution”, such as nucleotide and amino acid sequences. Development of this type of database involved not only design issues but the development of complex interfaces whereby researchers could both access existing data as well as submit new or revised data. Over the past few decades rapid developments in genomic and other molecular research technologies and developments in information technologies have combined to produce a tremendous amount of information related to molecular biology. It is the name given to these mathematical and computing approaches used to glean understanding of biological processes. The primary goal of bioinformatics is to increase our understanding of biological processes, and then it focuses on developing and applying computationally intensive techniques to achieve this goal. Now, it is also applied in the drug design or drug discovery.

### BRIEF SUMMARY OF THE INVENTION

The invention provides an easier and faster process for discovering potential treatment strategy for a given disease by identifying a therapeutic target than traditional drug discovery pipelines that require tremendous effort and time.

In one aspect, the invention provides a process for discovering potential treatment strategy for a given disease comprising the steps of:

(a) collecting up- and down-regulated genes of the given disease or cells from published microarray data and primary literatures to obtain an initial gene signature;
(b) converting the initial gene signature as collected in step (a) to form a protein-protein interaction (PPI) network;
(c) analyzing the PPI network topologically to obtain key regulators involved in the given disease, as referred to as bottleneck genes;
(d) defining one or more features of particular interests, and narrowing down the PPI network based on the defined features to retrieve the bottleneck genes for predicting the given disease;
(e) collecting additional genes involved in the protein complexes and genes in relation to the given disease after functional profiling, and merging them with the bottleneck genes as obtained in step (d) to obtain a final gene signature of the up- and down-regulated genes;
(f) querying a connectivity map using (1) the initial and final nasopharyngeal carcinoma (NPC) gene signatures respectively or (2) using normal and disease (e.g. Hepatocellular carcinoma or HCC) gene signatures to discover potential treatment strategy for the given disease.

In the other aspect, the invention provides a process for discovering a potential therapeutic agent for the treatment of NPC, comprising the steps of:

(a) collecting up- and down-regulated NPC genes from published microarray data and primary literatures to obtain an initial gene signature;
(b) converting the initial gene signature as collected in step (a) to form a protein-protein interaction (PPI) network;
(c) analyzing the PPI network topologically to obtain key regulators involved in tumorgenesis of NPC referred to as bottleneck genes;
(d) narrowing down the PPI network by pathway analysis to retrieve the bottleneck genes for predicting NPC carcinogenesis;
(e) collecting additional oncogenes, tumor suppressor genes, genes involved in protein complexes and genes in relation to NPC after functional profiling, and merging them with the bottleneck genes to form final gene signature of up- and down-regulated genes;
(f) querying a connectivity map using the initial and final NPC gene signatures respectively to discover potential drugs for treating NPC.

According to the invention, each of trichostatin A and trifluoperazine was found to be potential for treatment of NPC.

Other characteristics of the present invention will be clearly presented by the following detailed descriptions and drawings about the various embodiments and claims.

It is believed that a person of ordinary knowledge in the art where the present invention belongs can utilize the present invention to its broadest scope based on the descriptions herein with no need of further illustration. Therefore, the following descriptions should be understood as of demonstrative purpose instead of limitative in any way to the scope of the present invention.

### BRIEF DESCRIPTION OF THE SEVERAL VIEWS OF THE DRAWINGS

For the purpose of illustrating the invention, there are shown in the drawings embodiments which are presently preferred. It should be understood, however, that the invention is not limited to the preferred embodiments shown.

In the drawings:

FIG. 1-1 provides a schematic illustration of in silico approaches to narrow down NPC genes for targets identification and potential drug discovery, wherein 558 up-regulated and 933 down-regulated gene signatures were extracted and reorganized from primary literatures published in PubMed and various microarray studies; then, the 98 up-regulated clique and 51 down-regulated clique genes were derived from the protein-protein interaction (PPI) network by clique analysis; these clique genes were used to query DAVID for pathway analysis to obtain 24 up-regulated and 6 down-regulated bottleneck genes that curb multiple pathways; the cancer related pathways were used to search for the drugs currently under Clinical Trial; these bottleneck genes, combined with oncogenes and genes found by group functional profiling, were used to query the DrugBank and STITCH; additional genes appeared in complexes were added to increase the number of the query genes used in connectivity map (cMap), and a total of 38 up- and 10-down regulated genes were used as final gene signature for querying cMap to identify potential drugs.

FIG. 1-2 shows the highly interactive cliques and complexes associated with NPC gene signatures, including (A) 4-cliques and 5-cliques of NPC PPI network, wherein the query-query interaction network of the NPC up-regulated genes was a highly connected network containing 26 4-cliques and two 5-cliques; the two 5-cliques were grouped in red circles, oncogenes were marked in yellow and tumor suppressor genes were marked in green; BRCA1, TP53, MYC, EGFR, and CDC2 were the top five proteins involved in the largest number of cliques; (B) five major complexes associated with NPC up-regulated gene signature, wherein the up-regulated genes were marked in red, whereas down-regulated genes were marked in green, clique genes were marked in dark red (up-regulated cliques) and dark green (down-regulated cliques); and (C) Table of five major complexes associated with NPC after analysis using three public domain databases, wherein the proteins involved in complexes and proteins that were in NPC up-regulated cliques were listed.

FIG. 1-3 shows the inferred NPC PPI network queried with the characteristics of cliques belong to the top-ranked targets as determined by centrality calculation; wherein the nodes of the major sub-network (query-query PPI) and level one major sub-network of the NPC up-regulated PPI network are ranked by degree centrality (DC), closeness centrality (CC), and eccentricity centrality (EC), including (A) nodes of the major sub-network and (B) level one major sub-network are marked in grey, wherein the nodes also clique proteins were marked in red, ninety-eight queried that participated in the inferred cliques were ranked relatively higher than the other nodes in the NPC PPI major sub-network and level one major sub-network, the top 15 proteins ranked by different centrality in (C) the major sub-network and (D) the level one major sub-network were listed; those also the clique proteins were marked in red.

FIG. 1-4 provides the heatmap showing KEGG pathways with corresponding NPC final gene signature, wherein the up-regulated genes and the down-regulated genes in a given pathway were denoted as the red blocks and the green blocks, respectively; Amyotrophic Lateral Sclerosis (ALS), Jak-STAT signalling, adipocytokine signaling, neurodegenerative disease and Cell Communication were the pathways without down-regulated genes in the figure.

FIG. 1-5 provides possible molecular mechanism of NPC carcinogenesis by NPC “bottleneck” genes and IHC of selected proteins, including (A) possible molecular mechanism of NPC carcinogenesis, wherein the red blocks are genes up-regulated in NPC, whereas blue blocks were genes down-regulated, and the gene names marked in red were oncogenes, and gene names marked in green were tumor suppressor genes, arrow depicted activation, and gray line depicted inhibition, and they form complexes if two blocks were close to each other, the bigger red arrow showed the pathway reinforced because of the lack of inhibitor and existing of enhancer; and (B) IHC of selected proteins in NPC tumor, wherein the tumor cells of NPC samples were positive for p53 (A, a), BCL2 (B, b), BAX (C, c), and MYC (D, d) by IHC, the sections were developed by DAB and counterstained with hematoxylin. (Origin magnification ×200: A, B, C, and D; Origin magnification ×400: a, b, c, and d).

FIG. 1-6 provides the cMap analysis results, including (A) Table of top 10 small molecules in cMap analysis queried by various NPC gene signatures; (B) Dose-dependent cytotoxicity of Trichostatin A; and (C) Trifluoperazine; wherein NPC cell lines were incubated with various concentrations of Trichostatin A and Trifluoperazine for 72 hours, and cell viability was evaluated by XTT cell viability assay; the data were means±SD from three independent experiments.

FIG. 2-1 provides the protocol including collection, intersection, and validation of HCC-related genes in EHCO2: (A) gene sets in EHCO2 and their intersecting genes. The gray box indicates the number of genes reported in each set, while the intersection cell indicates the numbers of common genes. Each pair of datasets shares a small number of common genes, suggesting the heterogeneous nature of HCC. The bottom-left insert shows the frequency of genes reported. Most genes are reported only once; and (B) validation of up-regulated genes via Q-RT-PCR. RHAMM, INTS8, CDCA8, DEPDC1B, and KIAA0195 are over-expressed in 21 paired HCC patient samples.

FIG. 2-2 shows the CMap analysis flowchart, including eight sets of EHCO2 sets (Group 1), EHCO2 sets with various constraints, and 100-member random sets (Group 2), as well as two reference sets (Group 3), which were individually queried with CMap; wherein only drugs with a p-value of less than 0.05 and a negative enrichment score were retained.

FIG. 2-3 shows that Trichostatin A, Tanespimycin, and Thioguanosine inhibit cell proliferation; wherein each drug was administered at various concentrations (0.1 μM, 1 μM, and 10 μM) to 4 HCC cell lines, HepG2, PLC5, Mahlavu, and Huh7, for 72 hours; the cell viability was evaluated by the MTT assay: Trichostatin A (A), Tanespimycin (B), and Thioguanosine (C) exhibited cytotoxicity effect. The data represent the mean±SD from three independent experiments. (D) Ranking of Trichostatin A, Tanespimycin, and Thioguanosine from various bioinformatics analyses, such as clique.

FIG. 2-4 provides the comparison of the accuracy of predicted drugs from each set, showing the top 10 drugs from each set labeled according to their effectiveness.

FIG. 3-1 provides the Clustering Dendrogram for Group 1 in Example 3.

FIG. 3-2 shows the efficacy of drugs in the Group 1 sets in Example 3.

FIG. 3-3 provides the Clustering Dendrogram for Groups 2 and 3 in Example 3.

### DETAILED DESCRIPTION OF THE INVENTION

Unless defined otherwise, all technical and scientific terms used herein have the same meaning as commonly understood by a person skilled in the art to which this invention belongs. All publications mentioned herein are incorporated herein by reference to disclose and describe the methods and/or materials in connection with which the publications are cited.

As used herein, the singular forms “a”, “an”, and “the” include plural referents unless the context clearly dictates otherwise. Thus, for example, reference to “a sample” includes a plurality of such samples and equivalents thereof known to those skilled in the art.

The present invention provides a process for discovering a potential treatment strategy for a given disease, comprising the steps of:

(a) collecting up- and down-regulated genes of the given disease from published microarray data and primary literatures to obtain an initial gene signature;
(b) converting the initiate gene signature as collected in step (a) to form a protein-protein interaction (PPI) network;
(c) analyzing the PPI network topologically to obtain key regulators involved in the given disease referred to as bottleneck genes;
(d) defining one or more features of particular interests, and narrowing down the PPI network based on the defined features to retrieve the bottleneck genes for predicting the given disease;
(e) collecting additional genes involved in the protein complexes and genes in relation of the given disease after functional profiling, and merging them with the bottleneck genes to obtain a final gene signature of the up- and down-regulated genes;
(g) querying a connectivity map using the initial and final NPC gene signatures respectively to discover potential treatment strategy for the given disease.

In one embodiment of the invention, a process for discovering potential treatment strategy for nasopharyngeal carcinoma (NPC) comprises the steps of:

(a) collecting up- and down-regulated NPC genes from published microarray data and the primary literatures to obtain an initial gene signature;
(b) converting the initial gene signature as collected in step (a) to form a protein-protein interaction (PPI) network;
(c) analyzing the PPI network topologically to obtain key regulators involved in tumorgenesis of NPC referred to as bottleneck genes;
(d) narrowing down the PPI network by pathway analysis to retrieve the bottleneck genes for predicting NPC carcinogenesis;
(e) collecting additional oncogenes, tumor suppressor genes, genes involved in protein complexes and genes obtained after functional profiling were merged with the bottleneck genes to form a final gene signature of up- and down-regulated genes;
(g) querying a connectivity map using the initial and final NPC gene signatures respectively to discover potential drugs for treating NPC.

Nasopharyngeal carcinoma (NPC) is a rare malignancy in most parts of the world, but is one of the most common cancers among those of Chinese or Asian ancestry. The etiology of NPC is thought to be associated with a complex interaction of genetic, Epstein-Barr virus exposure, environmental, and dietary factors. Although some oncogenes, tumor suppressor genes, and microarray expression data have been previously reported in NPC, a complete understanding of the pathogenesis of NPC in the context of global gene expression remains to be elucidated (1-9). It is not clear how to elucidate key regulators and identify potential drugs for NPC treatment.

Protein-protein interactions (PPI) are important for virtually every biological process. In a PPI network, nodes having more than one connection with another node are defined as hubs, and are more likely to be essential (10, 11). The key challenge facing a disease PPI network is the identification of a node or combination of nodes in the network whose perturbation might result in a desired therapeutic outcome. an integrated PPI web service was constructed as a bioinformatics tool to construct and to analyze the NPC network in this invention.

In addition to elucidating the pathogenesis of NPC, the refinement of current treatment modalities is also important. Although NPC is highly radiosensitive and chemosensitive, the treatment of patients with locoregionally advanced disease remains problematic.

According to the invention, NPC-associated genes inventory was established, and it is hypothesized that the PPI network, derived from the initiate gene signature, could be analyzed topologically to prioritize potential targets. A further pathway analysis and applied gene signature to drug-gene interaction databases and Connectivity Map (cMap) (13, 14) is performed to discover a potential treatment strategy. It was also found that many specific molecular targeted therapies, epigenetic therapies, and EBV-based immunotherapy have been developed and are in clinical trials. It is supposed that a small molecule may potentially reverse the disease signature if the molecule-induced signature is significantly negative-correlated with the disease-induced signature in cMap (15-17). Accordingly, a potential drug for treating a given disease may be identified from known drugs for the treatment of NPC by using an in silico screening approach followed by empirical validation.

This invention provides a niche for NPC PPI network construction, target prioritization, and potential drug identification based on the interaction between prioritized NPC targets (e.g. cliques and bottleneck genes) and drugs, which highlight a promising approach to address disease-related networks and to discover potential treatment strategy, such as a new therapeutic agent or a potential drug.

According to the invention, each of trichostatin A and trifluoperazine were found to be potential for treatment of NPC. Therefore, the invention provides a method for treating NPC comprising administrating to a subject in need thereof a therapeutically effective amount of trichostatin A. Further, the invention provides a method for treating NPC comprising administrating to a subject in need thereof a therapeutically effective amount of trifluoperazine.

The present invention will now be described more specifically with reference to the following embodiments, which are provided for the purpose of demonstration rather than limitation.

### EXAMPLES

### Example 1

1. Computational Methods

1.1 Acquiring NPC-Related Gene Sets and Constructing NPC Protein-Protein Interaction (PPI) Network

Two major components constituted the NPC-related gene expression signature in this invention. One component included the collection of the microarray profiles from three studies (Supplementary table S2) (4, 5, 7). All microarray data were the result of non-treated NPC tissues compared to normal nasopharyngeal tissues.

The second part of the gene collections consisted of the text mining of NPC-related PubMed abstracts. There were 4939 abstracts extracted from PubMed containing the keyword “Nasopharyngeal carcinoma” but not having the keywords “SNP” or “polymorphism.” To further extract the genes mentioned in the abstracts, we first entered all these abstracts into AIIAGMT (Adaptive Internet Intelligent Agents laboratory's Gene Mention Tagger) (18). The Gene Name Service (19) was used to translate these gene names into corresponding gene identifiers, such as the official gene symbol and the Entrez gene ID. Then, we manually read the top 10 abstracts with most genes mentioned from the method of the invention and another 150 abstracts published from 2007 to 2008 to further annotate the genes as up-regulated or down-regulated genes. An web site-based inventory including these genes and annotations was constructed. The NPC-related genes as collected above were inputted as query terms into the POINeT (12) to detect the PPI in NPC.

1.2 Evaluation of Cliques and Complexes from the PPI Network

The cliques of the PPI network were calculated from the following definition of cliques, a term borrowed from Graph Theory. A clique was a part of a graph where all its nodes are completely connected to each other. In other words, a 3-clique was a completely connected graph of three nodes, which is a triangle. From this definition, CliquePOINT, which was embedded into POINeT, was developed to calculate these cliques in the NPC PPI network. Expanding the definition of the 3-clique, the number of 4-cliques and 5-cliques in the NPC PPI network was also counted, and there was no clique larger than 5-cliques in the NPC PPI network.

The complex information were further collected and integrated to obtain an abundant dataset from public domain databases, including the Human Protein Reference Database (HPRD) (20), the Protein Interacting in the Nucleus database (PINdb) (21), and the Comprehensive Resource of Mammalian protein complexes (CORUM) (22), and whether the cliques identified from the PPI network were involved in protein complexes were checked. The cliques having more than three proteins involved in complexes were found.

1.3 Ranking the Hubs in the PPI Network

To elucidate the relative roles of each node, we analyzed node centrality via POINeT, including degree centrality (DC), closeness centrality (CC), and eccentricity centrality (EC). DC is the number of links incident upon a node. CC represents the closeness between nodes in the biological network. EC is the longest distance required for a given node to reach the entire network. By conducting centrality calculation, nodes in global networks can be ranked and filtered using various network analysis formulas.

1.4 The Enriched Pathways from the CPDB Over-Representation Analysis

CPDB (ConsensusPathDB) (23) was used to perform over-representation analysis on the four sets of gene lists: (1) up-regulated genes in NPC, (2) down-regulated genes in NPC, (3) up-regulated genes after clique analysis, and (4) down-regulated genes after clique analysis. The significant pathway results were ranked by using an F score instead of the p-value given by CPDB. The F score was used to normalize two parameters: (A) the percentage of overlapping genes in the pathway and (B) the percentage of overlapping genes in the input list. To normalize these, we used the following formula:

$$F score = \frac{2 ( A \times B )}{( A + B )}$$

We compared the p-values to evaluate whether the p-values degrade after clique analysis and thereby gave each pathway a score of degradation (0=No and 1=Yes).

1.5 The Final NPC Gene Signature

The 98 up-clique and 51 down-clique genes were used as queries to perform functional annotation clustering on DAVID (Database for Annotation, Visualization, and Integrated Discovery) (24), respectively. The clustering was performed on seven pathway resources: BBID, BIOCARTA, EC_NUMBER, KEGG_COMPOUND, KEGG_PATHWAY, KEGG_REACTION, and PANTHER_PATHWAY. The classification stringency was set to “Medium”. For each cluster, the genes of the pathways were further intersected to obtain the “bottleneck” genes to obtain 24 up-regulated and 6 down-regulated bottleneck genes.

Among cliques, those, including oncogenes, tumor suppressor genes, genes involved in complex and genes found by group functional profiling, were added into the “bottleneck” genes list to obtain the final gene signature of NPC, including 38 up-regulated and 10 down-regulated genes.

1.6 Hierarchical Clustering the Final Gene Signature in KEGG Pathways

We used the final gene signature as queries to conduct the functional annotation clustering of DAVID against KEGG pathway database. A perl script was written to convert the pathway records (p<0.05) into get file, which can be uploaded onto GenePattern to perform hierarchical clustering and visualization. For up- and down-regulated genes, the values are 1 (red) and −1 (green), respectively. The distance measure for both genes (row) and pathways (column) was set to “Pearson correlation, absolute value”.

1.7 Known Drug Targets

To collect target genes of known drugs including FDA-approved drugs, drugs approved in Europe and other states and commercialized drugs, the chemical-protein links from STITCH (25) was downloaded. Then, Gene Name Service (19) was used to translate the protein ID to its corresponding HUGO-approved gene symbol and Entrez gene ID. The DrugCard file from Drug Bank (26) was downloaded. We selected known drugs, mapped the drugs' corresponding genes with the NPC up-regulated genes, and finally identified known drug targets in the NPC up-regulated PPI network.

1.8 Applying NPC Gene Signature to Connectivity Map (cMap)

Functional connections between various NPC gene signatures and gene signatures induced by small molecules were explored using the cMap database (13, 14). The up-regulated genes were grouped and their probe sets formed the up tag file, and so did the down-regulated genes. These two files were used to query the cMap database and the results showed the most significant similarities and dissimilarities to the database profiles. The 558 up and 993 down genes would convert to more than 1000 probe sets. Since the cMap could only take up to 1000 probe sets per input, three groups of NPC genes were used. The first group consisted of 100 randomly chosen sets of 100 up/down-regulated probe set from whole 558 up and 993 down NPC gene signatures. The second group consisted of 399 up and 443 down-regulated probe sets, which represent first 70% ranked queries served as hubs. The third group, the final gene signature consisting of 38 up genes and 10 down genes were obtained. Only drugs with negative scores and p-value less than 0.05 were retained.

2. Biological Methods

2.1 Immunohistochemical Analysis in NPC

Formalin-fixed paraffin-embedded biopsy specimens of 143 NPC cases were collected and analyzed for detection of the expression of p53 (mouse anti-human p53, 1:50, Dako, Carpinteria, Calif., USA), BCL2 (mouse anti-BCL2, 1:80, Dako, Carpinteria, Calif., USA), BAX (mouse anti-BAX, 1:400, Santa Crutz, Calif., USA), and MYC (mouse anti-MYC, 1:50, Santa Crutz, Calif., USA) by immunohistochemistry (IHC) with the institutional review board approval. Briefly, 5-6 μm of paraffin sections were deparaffinized and placed into citrate buffer for antigen retrieval once in microwave oven. After cooled down and rinsed with PBS, the sections were incubated with 5% normal goat serum followed by reaction with primary antibody for 30 min at room temperature, then washed with PBS three times, 3 min each. The sections were reacted with biotinylated second antibody followed by streptavidin-biotin complex in the LsAB detection kit (Dako, Carpinteria, Calif., USA) at room temperature for 10 min and washed with PBS again. The sections were colorized using freshly prepared diaminobenzidine (DAB) solution containing H₂O₂ for 2-5 min. After washed with running water and counterstained with hematoxylin, the sections were dehydrated and mounted. Positive staining showed brownish granular deposits in the nuclei of cells. Adenocarcinoma and normal mucosa gland of the colon were used as positive and negative controls, respectively, for the expression of p53 and MYC; whereas follicular lymphoma was used for the positive and negative control of the expression of BCL2 and BAX.

2.2 Cell Culture and Cell Viability Test

NPC cell lines, TW01, TW03, and TW04 provided by Dr. C T Lin (National Taiwan University, Taiwan), were derived from primary nasopharyngeal tumors of Chinese patients with de novo NPC and had been tested and authenticated (27). NPC cell line BM1, provided by Dr. S K Liao (Chang Gung University, Taiwan), was derived from bone metastatic lesions of an NPC patient (28). NPC cell lines were maintained in DMEM with 10% FBS containing penicillin (100 U/mL) and streptomycin (100 μg/mL) in 5% CO₂ at 37° C. Cell viability was determined using the XTT cell viability assay kit (Sigma-Aldrich, St. Louis, USA), according to the manufacturer's instructions. Twenty-four hours after seeding cells at a concentration of 2×10³ cells/well in 100 μl culture medium in a 96-well microplate, cells were then treated with Trichostatin A (Sigma-Aldrich) and Trifluoperazine (Sigma-Aldrich), the selected small molecules from cMap. Cells were exposed with or without small molecules for 72 hours at different concentrations. Then, the cells were incubated with medium containing XTT in an amount equal to 20% of the culture medium volume for 2 hours. Optical density was measured using a microplate reader (Spectral Max250) at 450 nm.

3. Results

3.1 NPC Gene Collections

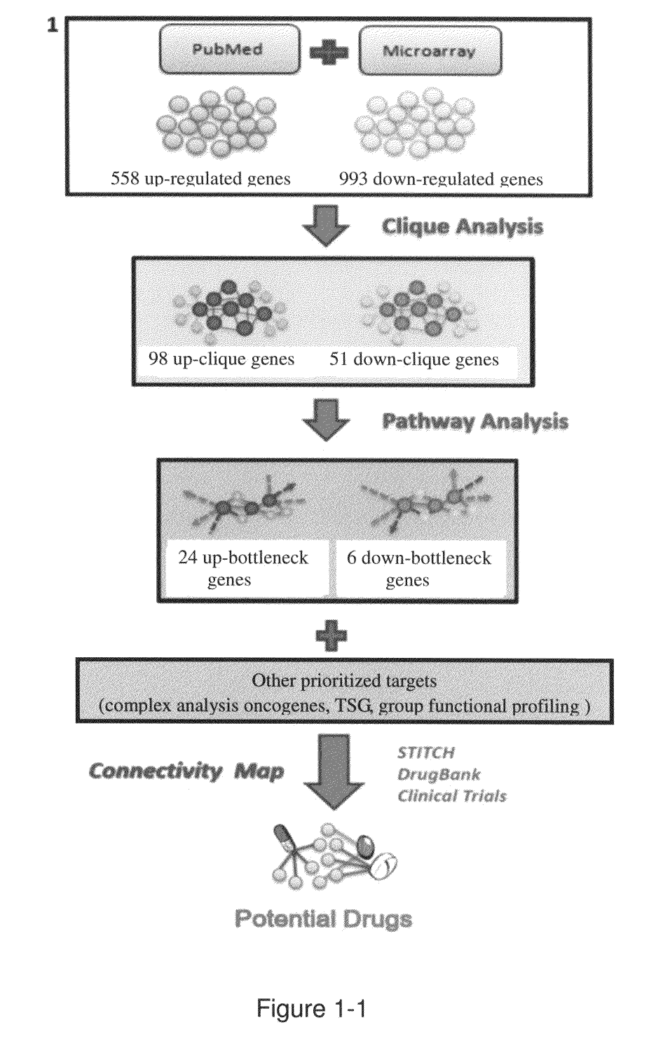

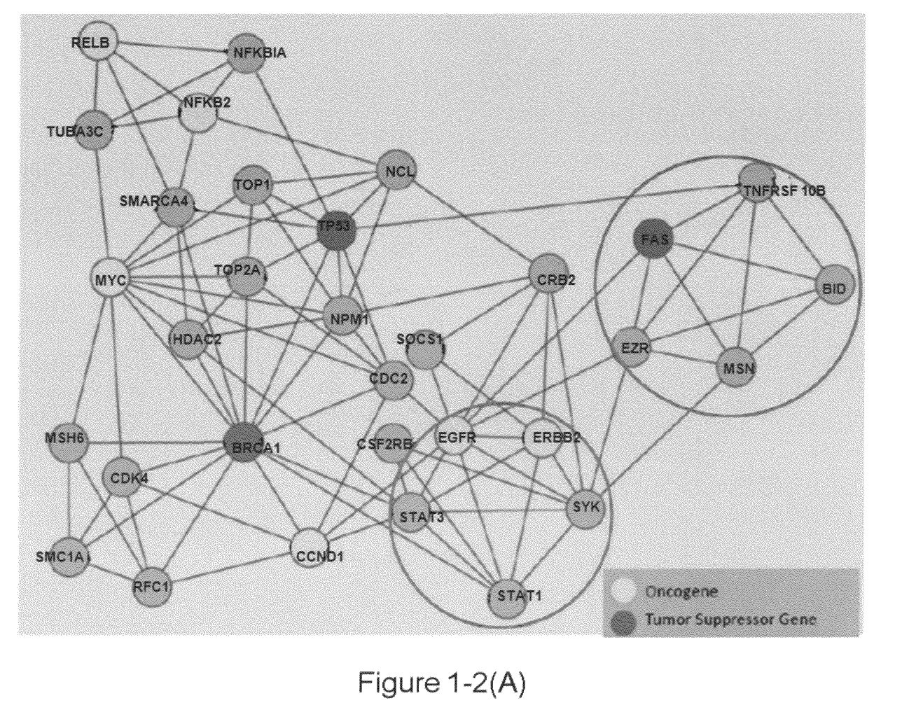

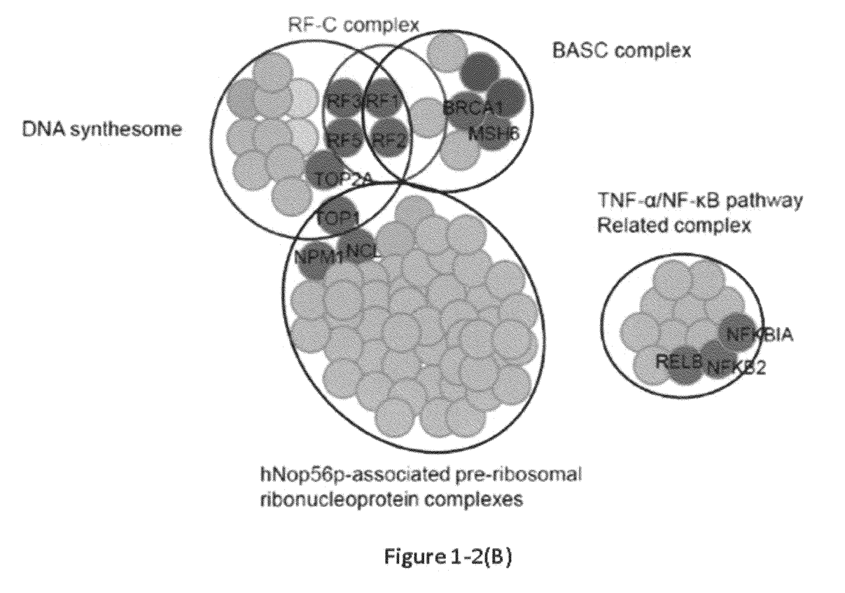

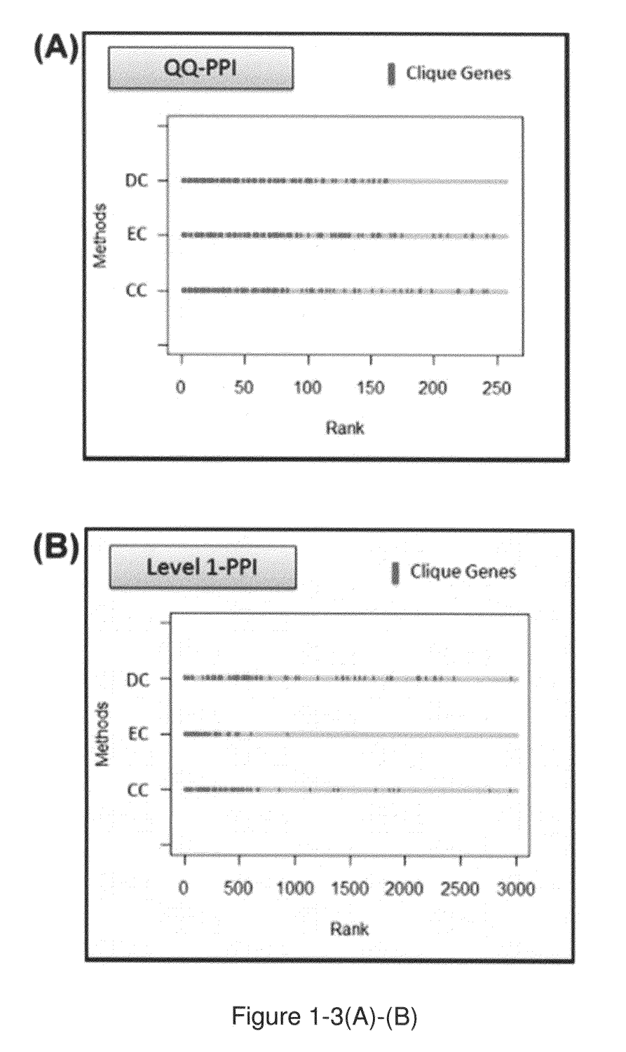

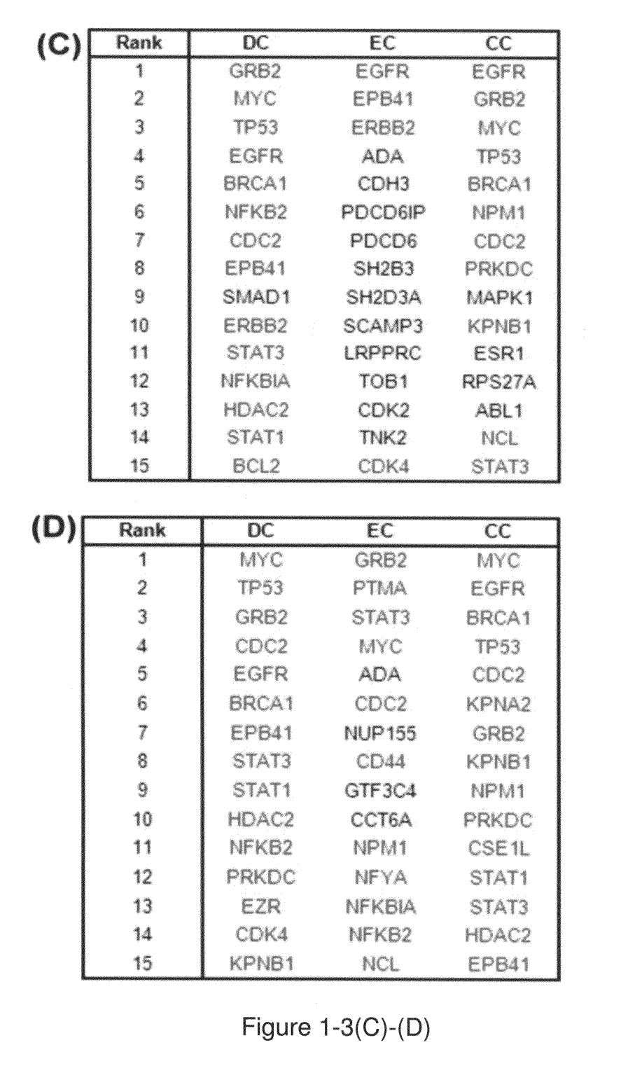

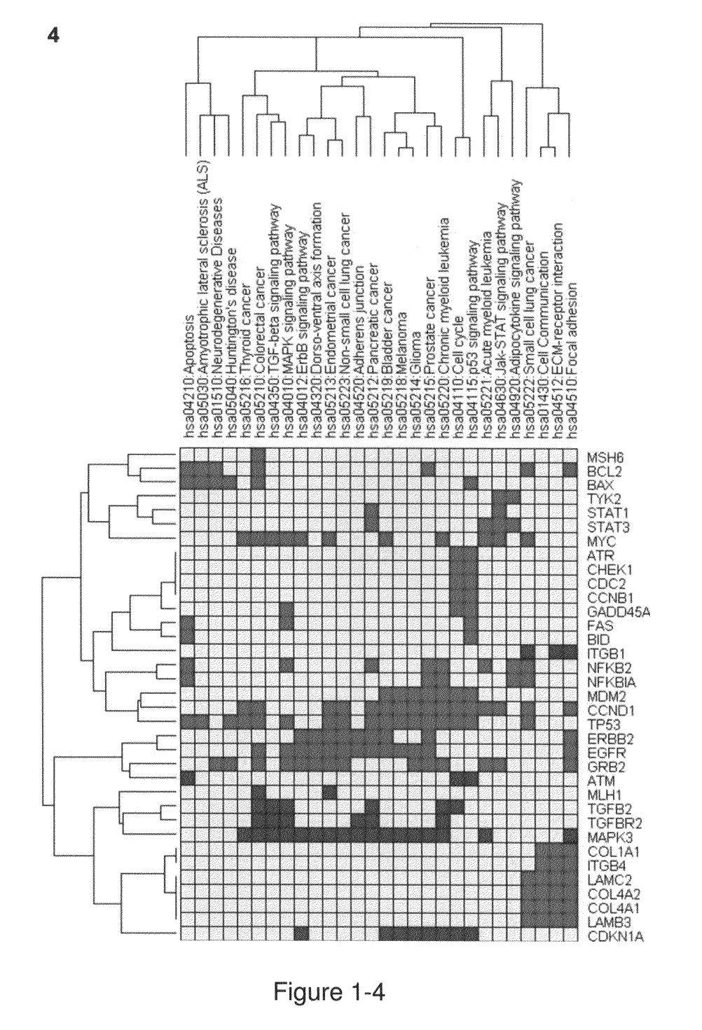

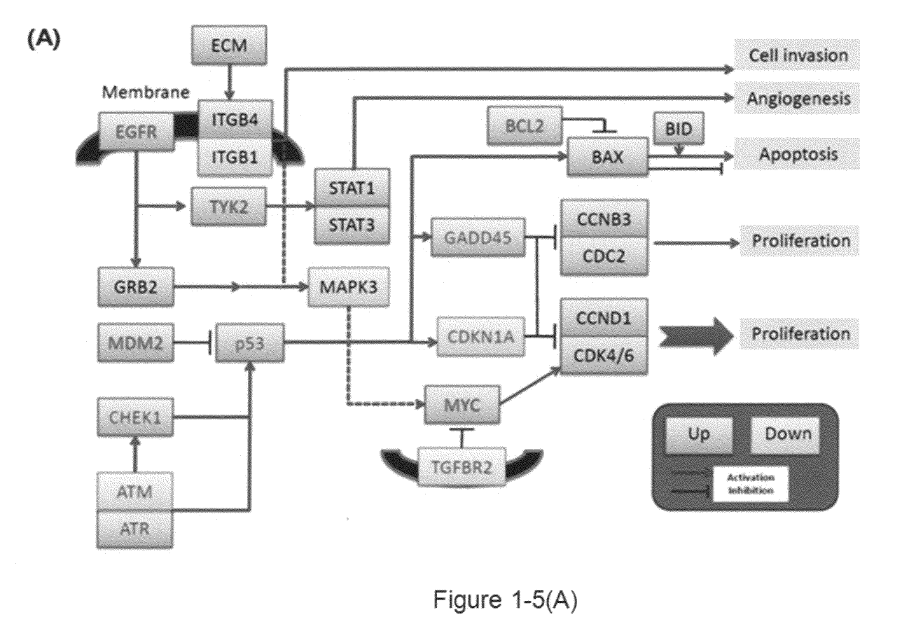

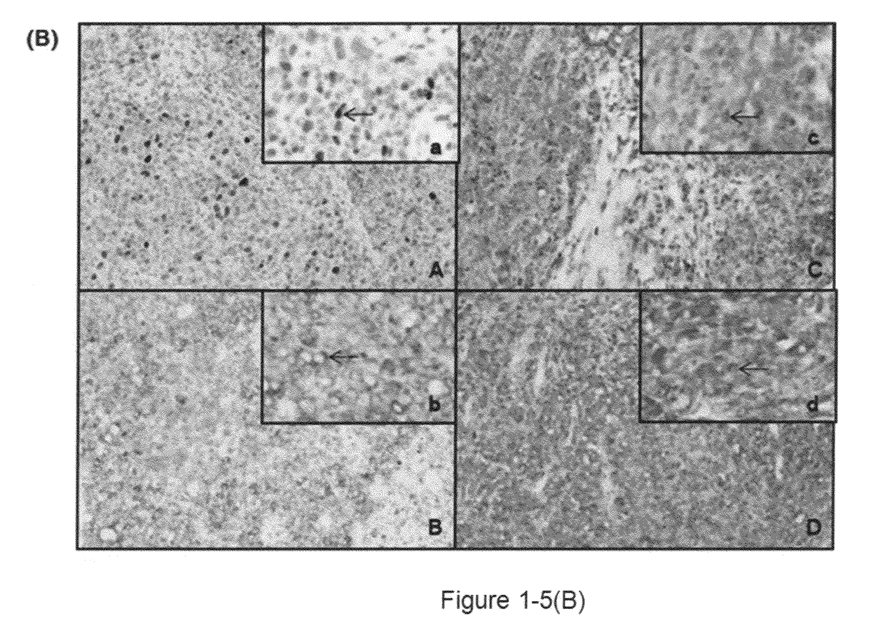

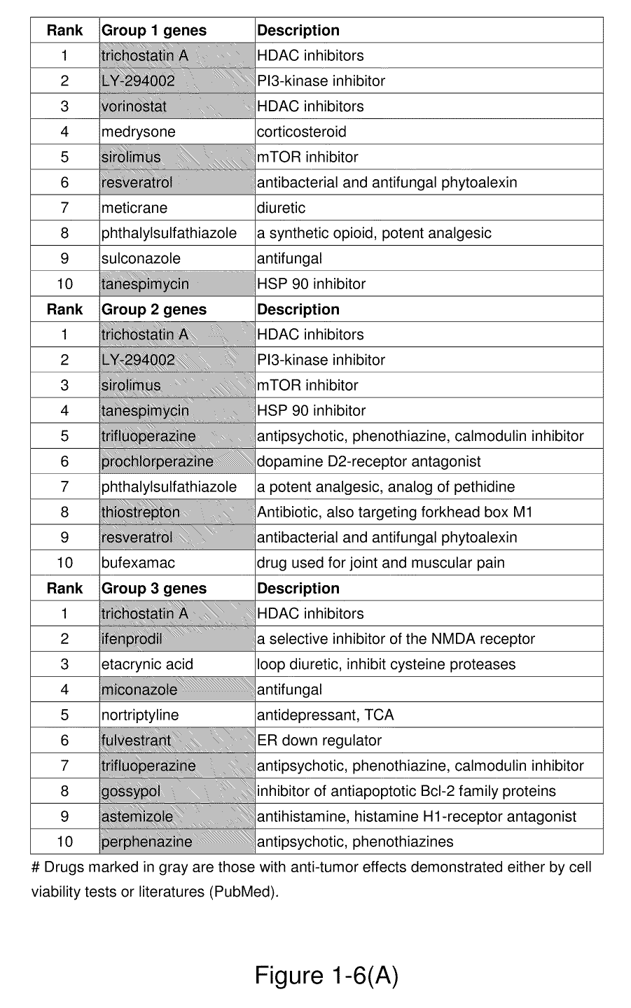

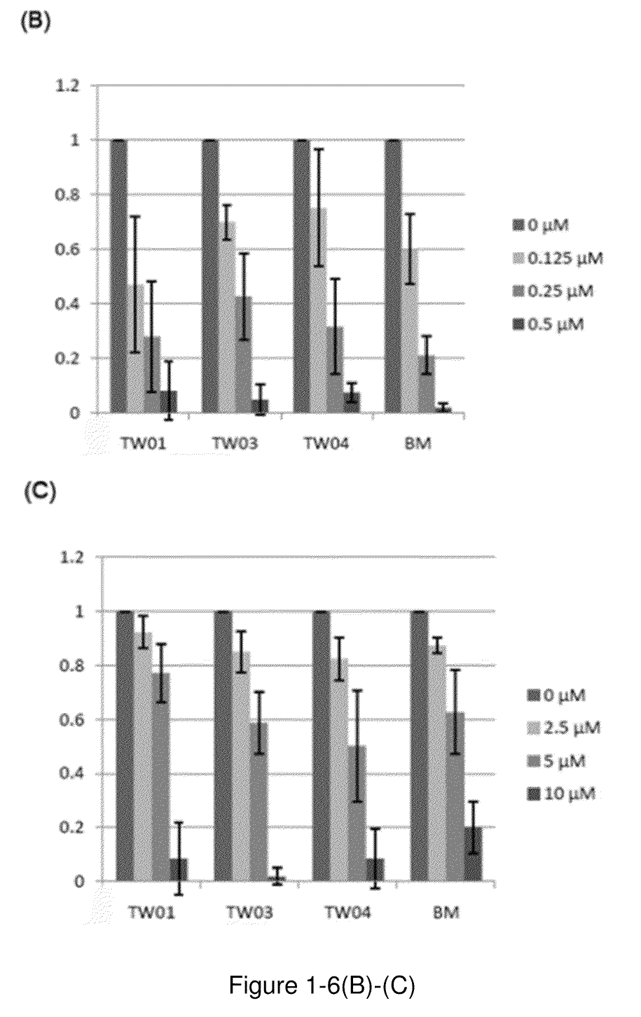

To systematically analyze the gene expression signatures of NPC and identify potential drugs for NPC, we have set up in silico approaches (FIG. 1-1). We collected the NPC gene sets from two sources: one gene set from PubMed with 70 up- and 78 down-regulated genes, and the other from three major microarray studies (4, 5, 7) (Supplementary table S2) with 512 up-regulated genes and 936 down-regulated genes. By merging these two datasets, an inventory containing the gene expression signatures of NPC including 558 up-regulated genes and 993 down-regulated genes were established.

3.2 Inferred NPC PPI Network

To discover the potential interaction networks of these seemingly unrelated NPC up-regulated and down-regulated genes, the website tool, POINeT, was used to detect the PPI in NPC. Despite many queries without interacting proteins based on our PPI collections in POINeT, the queries of NPC-related proteins formed a highly connected interactome. A total of 8,231 and 7,728 PPIs were identified in the up-regulated and down-regulated NPC PPI networks, respectively. The fundamental structural details revealed that 257 out of 558 NPC up-regulated genes interact with each other and form 492 query-query PPIs, constituting the interaction networks. On the other hand, 324 out of 993 NPC down-regulated queries form 395 query-query PPIs.

3.3 The Inferred NPC Network Consists of Highly Interactive Cliques and Complexes

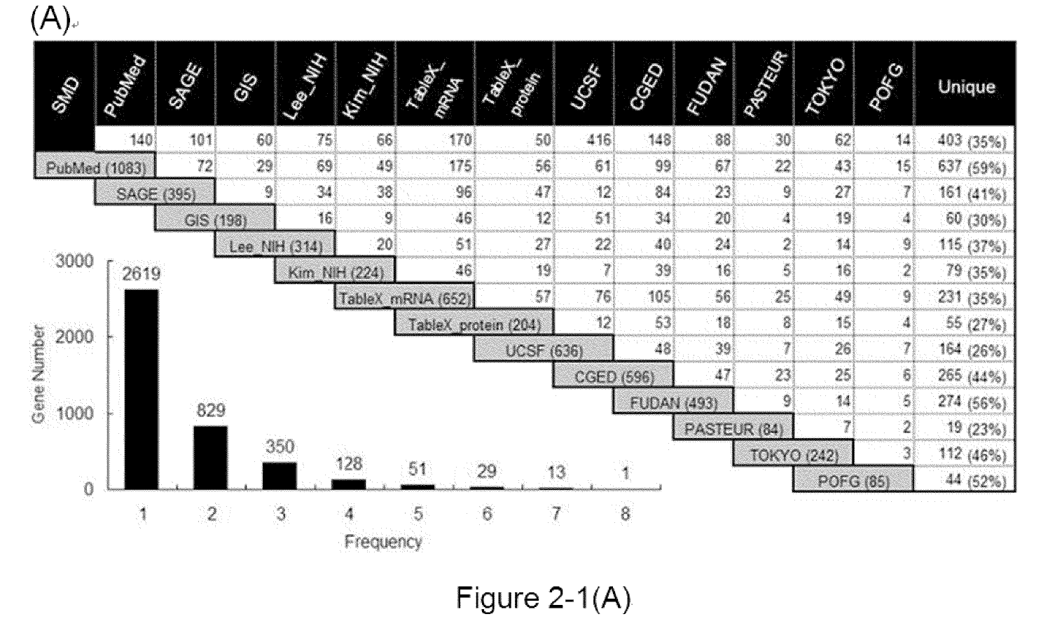

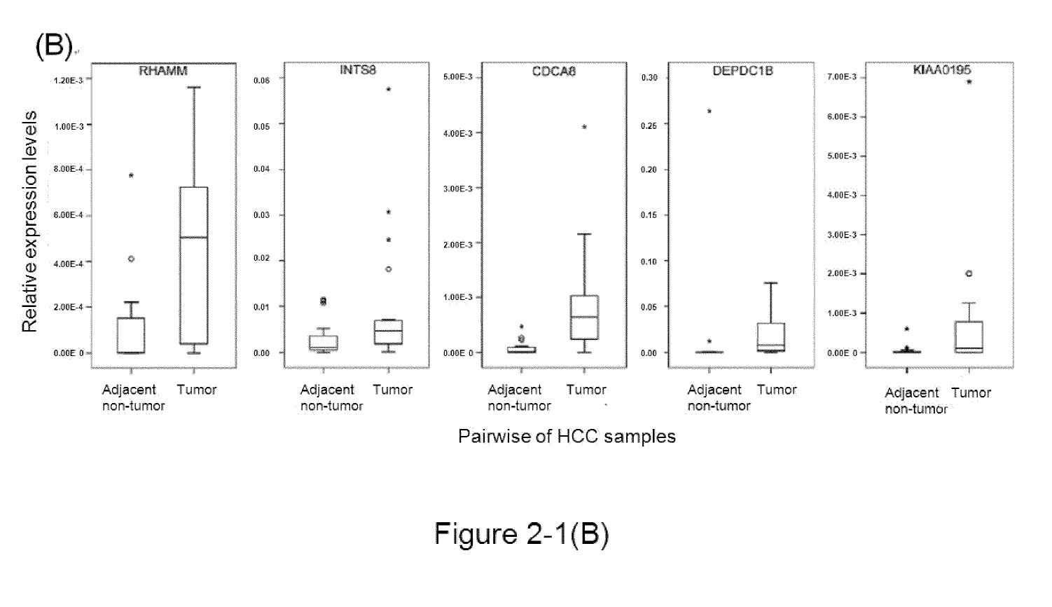

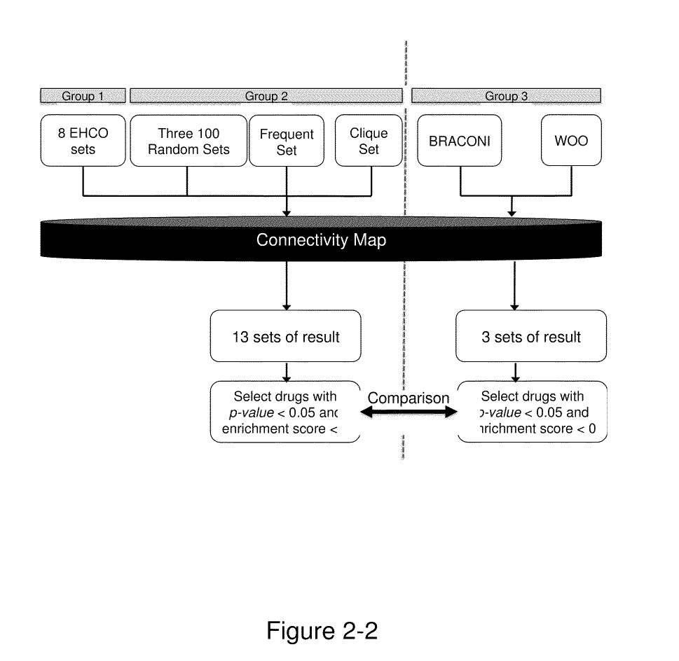

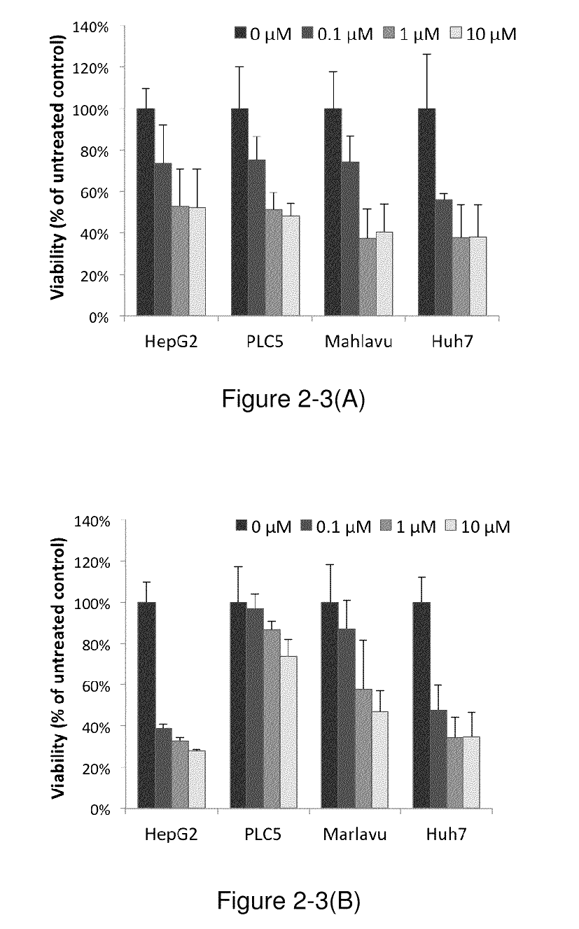

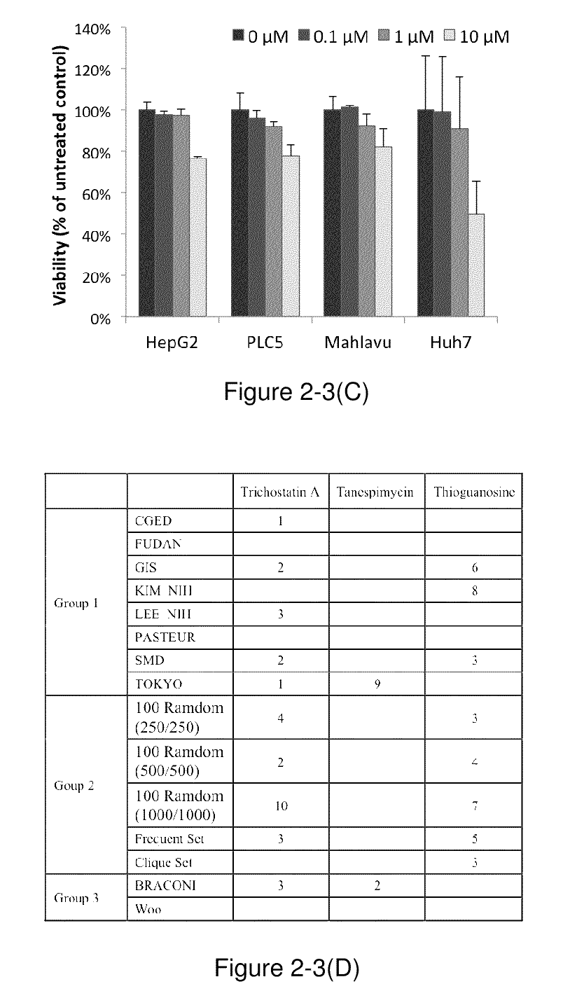

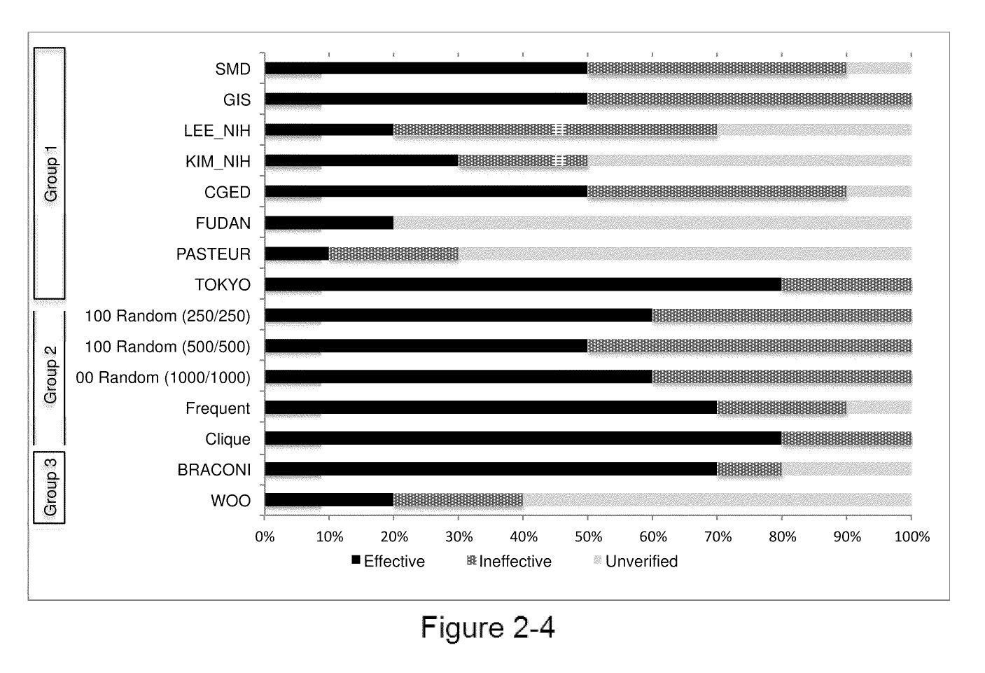

Of particular interests in the inferred NPC PPI network is the presence of cliques (29), which refer to completely connected sub-graphs. Nodes within a clique have interactions with all the others. In our analysis, the NPC query-query network contains 198 and 21 sub-graphs of cliques in up-regulated genes and down-regulated genes, respectively. In the up-regulated PPI network, there are 170 3-cliques, 26 4-cliques, and two 5-cliques (FIG. 1-2A, Supplementary table S6). The top 30 proteins involved in cliques are listed and ranked by the number of associated cliques (Supplementary table S7). BRCA1, MYC, EGFR, TP53 and CDC2 are the top five proteins participating in a large number of cliques.

The analysis of node centrality characteristics may provide insights into the relative roles and features of each node. To address whether clique proteins are relatively more important hubs in the PPI network, we prioritized the nodes of the major sub-network, which consists of 247 query proteins (or nodes), in the NPC up-regulated PPI network (Supplementary table S8). The 3,725 nodes of level one major sub-network, which consists of query proteins with neighbour nodes, were also ranked. Different ranking methods, including DC, EC, and CC, were used. Those nodes, which are also clique proteins, are ranked higher than those that are not clique proteins (FIG. 1-3).

Since cliques have more interactions than the rest of the graph, and these protein interactions may be responsible for the formation of protein complexes or functional modules (30), we further integrated and searched for protein complexes from HPRD (20), CORUM (22), and PINdb (21). Of up-regulated cliques, there are five 3-cliques and four 4-cliques involved in five protein complexes (FIGS. 1-2B, 1-2C). The DNA synthesome, also known as the DNA replication complex, consists of 15 subunits, including DNA polymerase, DNA topoisomerase, and the RF-C complex (replication factor C complex) (31). The RF-C complex is a heteropentameric protein that is essential for DNA replication and repair and is also a clamp loader required for the loading of PCNA onto dsDNA (32-34). The BASC complex, BRCA1-associated genome surveillance that consists of ATM, BLM, MSH2, MSH6, MLH1, and RF-C, is involved in the recognition and repair of aberrant DNA structure (35). Another complex, the hNop56p-associated pre-ribosomal ribonucleoprotein complex, is associated with ribosome biogenesis (36). Interestingly, many proteins are shared in these complexes. Finally, there is one complex involved in the TNF-α/NF-κB pathway (37). The above finding raises the possibility that NPC pathogenesis might be related to aberrant DNA replication, DNA repair, and the TNF-α/NF-κB pathway. To the best of our knowledge, this finding will be the first report to provide the relationship between these complexes and NPC carcinogenesis. The few proteins in the above five complexes that have been shown to be related to NPC include RFC1, PCNA, TOP1, ATM, MLH1, RPL21, and RPL31.

3.4 Oncogenes and Tumor Suppressor Genes in NPC Clique Genes

Six oncogenes, including EGFR, ERBB2, MYC, RELB, NFKB2, and CCND1, were found in the 4-cliques and 5-cliques from the inferred up-regulated NPC network.

Overexpression of these oncogenes in NPC, except ERBB2, was suggested to be related to NPC carcinogenesis (38-42). Three tumor suppressor genes were found in the 51 down-regulated clique genes, including CDKN1A, MLH1 and ATM. Both CDKN1A and ATM have been shown to be down regulated in NPC (7, 43).

In this invention, three tumor suppressor genes were found in the 98 up-regulated cliques, including BRCA1, TP53, and FAS. Briefly, BRCA1, and a nuclear phosphoprotein was found to play a role in maintaining genomic stability. Mutations in BRCA1 are responsible for approximately 40% of inherited breast cancers and more than 80% of inherited breast and ovarian cancers; however, its expression in NPC is still unknown. TP53 encodes the tumor protein p53, which responds to diverse cellular stresses to regulate target genes that induce cell cycle arrest, apoptosis, senescence, and DNA repair. In normal cells, p53 is rapidly turned-over by a negative feedback loop mediated by MDM2. Mutant p53, noted in 30-50% cancer, was found to be unable to induce MDM2 transcription and escapes degradation, thereby leading to its accumulation at a very high level in cancer (44). Although p53 levels are high in NPC, the mutation of TP53 gene is relatively rare. Accumulated p53 in NPC was believed to be mediated by EBV LMP1 (9, 40, 45). Two reasons have been proposed to explain why wild-type p53 fails to induce apoptosis in NPC: low ARF levels due to promoter hypermethylation and excess mutated p63. Wild-type p53 function may be eliminated by the inactivation of the ARF gene, which encodes proteins that sequester MDM2 from antagonizing p53 (44). Mutated p63, which lacks the N-terminal transactivation domain required to activate apoptosis, binds to normal p63 (and p53) (9). FAS protein is a member of the TNF-receptor superfamily and contains a death domain. It plays a central role in the physiological regulation of programmed cell death, and has been implicated in the pathogenesis of various malignancies and diseases of the immune system. Fas ligand overexpression has been shown to be an unfavorable prognostic marker in NPC (46, 47).

3.5 Findings by Gene Group Functional Profiling

To address how the NPC signature might turn biological process (BP) term groups (by Gene Ontology) on or off, 98 up- and 51 down-regulated clique genes were subjected to g:Profiler, respectively (48). A large BP term group is shared by both up-regulated and down-regulated clique genes (FIG. 1-S1). The group is mainly related to the regulation of biological processes, cell cycle, cell death, and cell development. These important biological functions are altered, thereby leading to the activation of p53 to deal with the disturbed physiological circumstances. Among the down-regulated clique genes, three genes, including CDKN1A, HDAC3, and PRKCZ, are shown to be related to the “regulation of programmed cell death” and the “regulation of apoptosis” by using Traceable author (TAS) (FIG. 1-S2). The genes with TAS references in the up-regulated clique genes in the phosphorylation group are ERBB2, STAT1, and TYK2. Overall, we used gene group profiling to further identify three down-regulated genes and three up-regulated genes that relate to the growth of tumors.

3.6 Pathway Analysis of NPC Gene Signatures

To find the enriched pathways of our NPC gene signature, we performed an over-representation pathway analysis on CPDB (23). Under the threshold of a p-value <0.01, there were 484 enriched pathways for up-regulated genes and 222 enriched pathways for down-regulated genes in the original NPC signature; 409 enriched pathways were found for up-regulated genes and 294 enriched pathways were found for down-regulated genes by using the clique analysis. To avoid the complication that small pathways are relatively easier to rank higher according to their p-value, we used the F score to normalize the ranking. From the results of the intersection of the top 100 enriched pathways of up-regulated gene signature, many pathways are directly related to cancer, such as the p53 signaling pathway, cell cycle related pathways, bladder cancer pathways, lung cancer pathways, prostate cancer pathways, and pancreatic cancer pathways (Supplementary table S9, S10). Moreover, most of the enriched pathways and their p-values did not degrade after clique analysis, suggesting that the clique analysis tends to remove genes not involved in the enriched pathways of our NPC gene signatures.

Furthermore, another pathway analysis was performed for NPC final gene signature by using DAVID. The clustering result shows that the final gene signature can be divided into 3 groups. All groups are closely related to cancers, signaling and cell communications. This analysis provides a convenient way to biologically interpret at the “biological module” level (24). To provide a more insightful view of the relationships between the final gene signature and KEGG pathways, we downloaded the pathway records (p<0.01) to perform hierarchical clustering (FIG. 1-4) using GenePattern. Most of the pathways are shown to have down-regulated genes that might cause disruption, whereas there are five pathways having no down-regulated blocks. They are Amyotrophic Lateral Sclerosis (ALS), Jak-STAT signaling, adipocytokine signaling, neurodegenerative disease and cell communication pathways. In addition, the tumor suppressor, ATM, is shown to be down-regulated in only anti-tumor pathways such as apoptosis, p53 signaling pathway and cell cycle. It implies that the ATM could be an important missing piece in NPC.

Finally, to investigate how the final NPC gene signature connects with each other in pathways, we manually referred the KEGG pathways to draw a possible molecular mechanism of NPC carcinogenesis (FIG. 1-5A). CDKN1A is down-regulated and loses its function of inhibition against the complex of CCND1 and DNK4/6. Meanwhile, due to the down-regulation of TGFBR2, a tumor suppressor, MYC activates the CCND1 and DNK4/6 complex for cell proliferation. In addition, BCL2 blocks the path to apoptosis. IHC studies of selected four final up-regulated genes, including TP53, BCL2, BAX, and MYC, were performed and all of them were shown to be up-regulated in tumor cells (FIG. 1-5B). The expression of p53 was mainly in the nuclei of tumor cells and the BCL2 and BAX were mainly in the cytoplasm, and the MYC was presented in both nuclei and cytoplasm of the target cells.

3.7 Known Drug Targets

To annotate the NPC up-regulated genes with known drug targets, we integrated databases from STITCH (25) and Drug Bank (26). We thereby derived 566 and 827 drugs target up-regulated and down-regulated genes, respectively. 289 and 203 known drugs target up-clique and down-clique genes, respectively. The 191 drugs target up-bottleneck genes and oncogenes, whereas 100 drugs target down-bottleneck genes and tumor suppressor genes. Some well-known chemotherapeutic agents already used in several cancers are among the top 100 drugs target up-clique genes. These drugs include paclitaxel, doxorubicin, etoposide, and cisplatin. Many of these drugs are being studied in NPC clinical trials, suggesting that our target prioritizations, particularly those not currently being used in clinical trials, might reveal potential therapeutic agents for the treatment of NPC, alone or in combination with older chemotherapeutic agents.

3.8 Finding Candidate Drugs for NPC from Drugs being Used or being Studied in Clinical Trials in Cancers Whose Pathways are Related to NPC

From the results of the pathway analysis, NPC may be related to several cancer pathways, including prostate cancer, bladder cancer, pancreatic cancer, chronic myeloid leukemia (CML), colorectal cancer, and small cell lung cancer. We derived 1692 chemical names with 3603 clinical trial records of the six types of cancers with refined search limited on drug from the ClinicalTrials database. By intersecting the chemical names with 289 up-clique drugs, we obtained 106 up-clique drugs under clinical trials. We then manually selected 83 drugs which are used as anti-tumor drugs in those clinical trials. Out of the 83 drugs, 11 drugs are under NPC clinical trials. Moreover, 66 of the 83 drugs are targeting up-bottleneck genes and oncogenes. After excluding the drugs already in clinical trial for NPC, 57 drugs remain. These candidate drugs might be important potential drugs for future NPC treatment. Also, 26 chemotherapeutic agents suggested to treat these cancers at different stages were retrieved from the NCCN (national comprehensive cancer network) clinical practice guidelines (Supplementary table S15). Individual or combined usage of the above known drugs may improve current NPC treatment with enhanced therapeutic effects and minimized side effects.

3.9 Identifying Potential Small Molecules for NPC Treatment by Applying NPC Gene Signature to cMap

Bioactive small molecules in cMap that reverse the gene signature of NPC may be the potential drugs to kill NPC cells. We used three groups of NPC gene signatures to query cMap database. The first group are genes randomly selected from whole NPC 559 up- and 993 down-regulated gene signature; the second group consists of first 70% ranked queries served as hubs; the third group are the final gene signature, consisting of 38 up- and 10 down-regulated genes. By querying cMap with the first, the second and the third group genes, there are 6, 8 and 8 drugs respectively among the 10 top-ranked small molecules with anti-tumor effect (either from cell viability tests or PubMed literatures) (FIG. 1-6A). Here we show cell viability tests of two drugs, trichostatin A and trifluoperazine, whose gene signatures in cMap significantly are negative-correlated with gene signature of NPC (FIG. 1-6B, 1-6C). Trichostatin A, a member of HDACIs (Histone Deacetylase Inhibitors), has been used with other anti-neoplastic agents in several clinical trials. Trifluoperazine, a typical antipsychotic drug of the phenothiazine group, can induce apoptosis of B16 melanoma cells (49) and leukemic cells (50). Both of them may have potential for treating NPC in the future.

### Example 2

Materials and Methods

Collection of HCC-Related Gene Expression Signatures

A fundamental part of EHCO2 is the collection of 14 HCC-related gene sets from PubMed as well as diverse high-throughput studies and computational predictions and validations (FIG. 2-1A). The details of each set are listed in the supplementary material.

Validation of EHCO2 genes by Q-RT-PCR

The mRNA expression levels were determined by quantitative RT-PCR in 21 pairs of HCC patients (from Taiwan Liver Cancer Network, see Acknowledgement). The results were normalized to the mRNA expression level of GAPDH in each sample (FIG. 2-1B).

Generation of HCC Test Sets

Three groups of datasets were used in this study; the details are summarized in Table 2-1.

TABLE 2-1
HCC sets criteria and individual gene count.

| | | Number of up/down | | | |
|---|---|---|---|---|---|
| Group | Name | regulated genes | Sample Size | Features | Selection Criteria |
| 1 | SMD | 90/180 | 102 primary HCC and 74 | | Intersected |
| | | | adjacent normal | | with STITCH³⁸ |
| | GIS | 160/38 | 37 HBV | HBV | |
| | LEE_NIH | 161/153 | 91 human HCC and 7 | Mouse vs | |
| | | | mouse HCC | human models | |
| | KIM_NIH | 46/178 | 59 cirrhotic tissues, 14 | | |
| | | | adjacent normal tissues | | |
| | CGED | 305/291 | 120 HCC tissues, 86 non-tumor | | |
| | | | adjacent normal tissues | | |
| | | | and 32 normal liver tissue | | |
| | FUDAN | 201/292 | 29 HCC and 29 adjacent | HBV | |
| | | | normal tissues | | |
| | PASTEUR | 31/53 | 15 HCC tissues | HBV, HCV | |
| | TOKYO | 94/147 | 20 HCC and 20 non-tumor | | |
| | | | adjacent normal tissues | | |
| 2 | 100 Random | 250/250 | | | Randomly selected |
| | sets | | | | from EHCO2 |
| | 100 Random | 500/500 | | | Randomly selected |
| | Sets | | | | from EHCO2 |
| | 100 Random | 1000/1000 | | | Randomly selected |
| | Sets | | | | from EHCO2 |
| | Frequent Set | 222/182 | | | up and down genes |
| | | | | | with 3 or more |
| | | | | | references in EHCO2 |
| | Clique Set | 148/32 | | | Genes belong |
| | | | | | to 4 cliques |
| 3 | BRACONI | 47/26 | 81 HCC tissues | Vascular | |
| | | | | invasion | |
| | WOO | 37/13 | 139 HCC tissues | Potential | |
| | | | | driver genes | |

Group 1 contained the original 8 sets of microarray-based HCC gene expression profiles from EHCO2. Group 2 contained sets derived from Group 1, including randomized sets, sets derived from “Clique analysis” and “frequency count”. Group 3 contained sets derived from two recent HCC studies.^{18,19} The details of these groups are described in the supplementary material.

CMap Analysis

The CMap analysis step is illustrated in FIG. 2. Each set, consisting of up- and down-regulated genes, was input into CMap, according to the program's instructions. Only drugs with negative scores and p-values of less than 0.05 were retained. Drug occurrences were summed up and used to rank the drugs.

Chemicals, Cell Culture, MTT Cell Viability Test and Clonogenic Assay

The HCC cell lines, Mahlavu, PLC5, HepG2, and Huh7, were cultured in Dulbecco's Modified Eagle Medium (DMEM; Seromed, Berlin, Germany) supplemented with 10% heat-inactivated fetal bovine serum, 100 μg/ml streptomycin, 100 μg/ml penicillin, and 2 mM L-glutamine in a humidified atmosphere containing 5% CO₂ at 37° C. The viability of the exposed cells was determined using the MTT cell viability assay kit (Sigma-Aldrich, St. Louis, USA), according to the manufacturer's instructions. Twenty-four hours after seeding cells at a concentration of 1.5×10³ cells/well in 100 μl of culture medium in a 96-well microplate, the cells were then treated with small molecules (details in Table 2-3S) selected from the drug lists from the CMap queried results. The cells were exposed to different concentrations of the small molecules for 72 hours. Control cells were incubated in the absence of small molecules. Afterwards, the cells were incubated with medium containing MTT for 2 hours. The optical density at 450 nm was measured using a microplate reader (Spectral Max250). For the clonogenic assay, Huh7 cells were seeded out in appropriate dilutions in a 6-well plate and treated with selected small molecules at various concentrations for 15 days. Colonies were fixed with glutaraldehyde (6.0% v/v), stained with crystal violet (0.5% w/v), and counted.

Results

Generation of EHCO2 Data

To systematically collect HCC-related genes, EHCO2 was expanded from 8 gene-set collections to 14 gene-set collections totaling 4,020 non-redundant genes. FIG. 1A shows the intersection between each gene set. The SMD and UCSF datasets had the greatest overlap of 416 genes. Interestingly, 35% of the SMD (403 out of 1,160) and 26% of the UCSF (164 out of 636) collections (referring to distinct genes in FIG. 2-1A) were genes that have not been reported in other gene sets. A cross-dataset comparison of 14 datasets revealed the 14 most occurring genes, which appeared at least 7 times in EHCO2 (FIG. 2-1A). However, the majority (−65%) of EHCO2 collections (see the bar chart in FIG. 2-1A) appeared only once, and there were some discrepancies among the gene sets, indicative of a need for an immediate further validation of these different measurements by using different HCC samples. Thus, we randomly selected five genes that had an “Up” expression pattern in EHCO2 for validation of their expression using quantitative RT-PCR. As shown in FIG. 2-1B, RHAMM, INTS8, CDCA8, DEPDC1B, and KIAA0195 are over-expressed in 21 of the paired HCC patient samples examined.

To shed new light on the in silico drug screening platform via CMap, three groups of gene signatures were created from the EHCO2 database with various techniques and from two other sources to reflect the heterogeneous nature of HCC and to allow a comparison of the results for the best prediction power.

Gene Signatures and CMap Analysis of Group 1 Sets (Original EHCO2 Sets)

Group 1 contained the original 8 microarray-based HCC gene expression profiles from EHCO2 (Table 2-1), with an average of 136 up-regulated and 166 down-regulated genes. Before the CMap analysis, the degree of data consistency was analyzed using Jaccard's Index (Supplementary methods) as a measure of set similarity (Table 2-51). Supplementary FIG. 2-1 shows that each set had a very high distance from (or low similarity to) each other based on the clustering result using Jaccard's distance (i.e., 1-Jaccard's Index) as the dissimilarity measure. Even though sets marked as up-regulated was ideally separated from those marked as down-regulated, the up-regulated KIM set showed very little resemblance to the others. The analysis showed the heterogeneous nature of HCC, indicating that HCC may comprise multiple states or subtypes.

After conducting CMap analysis, the top 10 drugs from each set were listed (FIG. 2-2S) for a total of 58 uniquely predicted drugs. Some of the drugs, such as trichostatin A and thioguanosine, had also been reported in previous studies (Table 2-2), suggesting some degree of power for discovering potential drugs.

TABLE 2-2
Potential 16 drugs identified from the Top 10 drugs of
Group 1 (EHCO2 sets) and Group 2 (Derived EHCO2 sets).

| Drug Name | Description | IC50 (μM) | Clonogenic Assay* | PubMed cancer | PubMed HCC |
|---|---|---|---|---|---|
| Tanespimycin | HSP90 inhibitor | <0.1 | N/A | Yes³³ | Yes³³ |
| Trichostatin A | HDAC inhibitor | 0.1~1 | N/A | Yes^{23, 24} | Yes³⁹ |
| Thioguanosine | Purine analog | 5~10 | N/A | Yes²⁵ | Yes²⁵ |
| Thioridazine | Antipsychotic drugs | 5~10 | N/A | Yes³⁷ | No |
| Phenoxybenzamine | Antihypertensive drugs | >10 | Effective | No | No |
| Trifluoperazine | Antipsychotic drugs | >10 | Effective | Yes³⁷ | No |
| Dipyridamole | Platelet aggregation inhibitor | >10 | Effective | Yes** | No |
| Sulconazole | Antifungal agents | >10 | Effective | No | No |
| Apigenin | Flavone | >10 | Effective | Yes** | Yes** |
| Chlorpromazine | Antipsychotic drugs | >10 | Effective | Yes^{35, 40} | No |
| Triflusal | Platelet aggregation inhibitor | >10 | Ineffective | No | No |
| Luteolin | Flavonoid | >10 | Ineffective | Yes²⁶ | Yes²⁶ |
| Medrysone | Steroid | >10 | Ineffective | No | No |
| 8-azaguanine | Purine analog | >10 | Ineffective | Yes⁴¹ | No |
| Repaglinide | Antidiabetic Agents | >10 | Ineffective | No | No |
| Alpha-estradiol | Hormone | >10 | Ineffective | No | No |

*Effectiveness in clonogenic assay is defined as reducing more than 50% colony number at 10 μM
**Reference in Supplementary materials

In contrast, FUDAN and PASTUER shared very few common drugs with the other sets, a result of their slight similarity in gene expression to the other sets. Subsequently, 27 drugs were analyzed empirically using the MTT and clonogenic assays; however, 16 out 27 were considered ineffective drugs (see later). Therefore, several strategies were formulated to devise enriched gene-sets to increase the drug selection accuracy.

Gene Expression of Group 2 (Derived EHCO2 Sets)

a) Generation of Random Sets

With the collection of candidate HCC-related genes, a compendium of possible combinations of simulated patient gene expression profiles could be created to reflect the heterogeneous nature of HCC. Due to the input limitation in the CMap tool, only a selection of 250 up-regulated and 250 down-regulated genes could be studied at each time. Thus, sets of 250 up-regulated and 250 down-regulated genes were selected randomly from the EHCO2 gene pools of up- and down-regulated sets, respectively, for a total of 100 sets.

Since a set of 500 genes comprises less than 15% of the total EHCO genes (4,020 genes), the number might not be adequate to represent a HCC patient. Selections of 500 up-regulated and 500 down-regulated genes and 1,000 up-regulated and 1,000 down-regulated genes were also made for further comparison. A computer program written in Ruby was implemented to handle the larger data inputs, which the original CMap program was unable to handle.

b) Generation of Frequent Set

Since EHCO2 genes were derived from a vast variety of sources with different microarray platforms, the “Frequent Set” of genes with more than 3 occurrences in the 14 sets of EHCO2 was created to represent the most confident HCC set.

c) Generation of Clique Set

The notion of clique from Graph Theory was utilized to enrich the gene sets. The protein-protein interaction network of EHCO2 genes was created, and cliques were extracted from this graph. A clique is a sub-graph where all the nodes are connected to each other. The simplest clique is the 3-clique, 3 interconnected nodes, or a triangle. The proteins in the clique set might represent a possible protein complex, which was the preferred candidate for targeting. Clique Analysis was used to search for 3-clique up to 6-clique. The number of genes in a 3-clique was over CMap's input constraint, while the 5-clique and 6-clique lacked down-regulated genes and were thus unsuitable for the CMap analysis. In short, the “Clique Set” was created using only genes in 4-cliques.

Gene Expression of Group 3 Sets (Reference Sets)

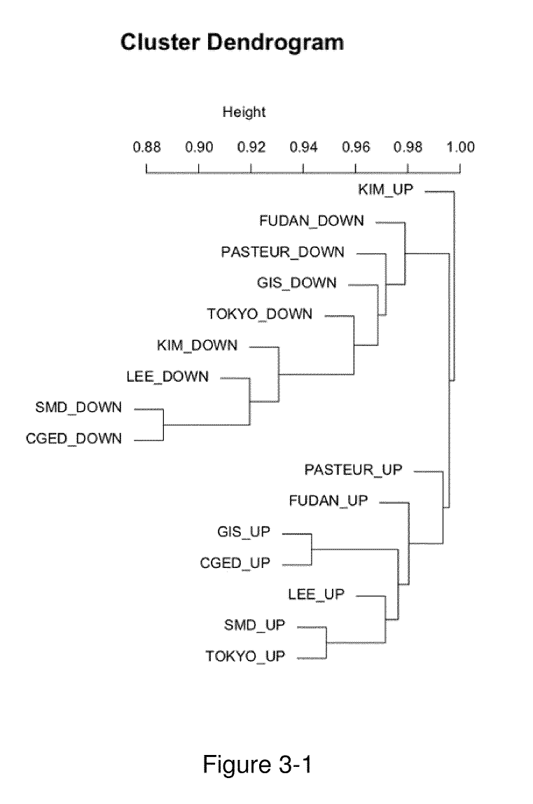

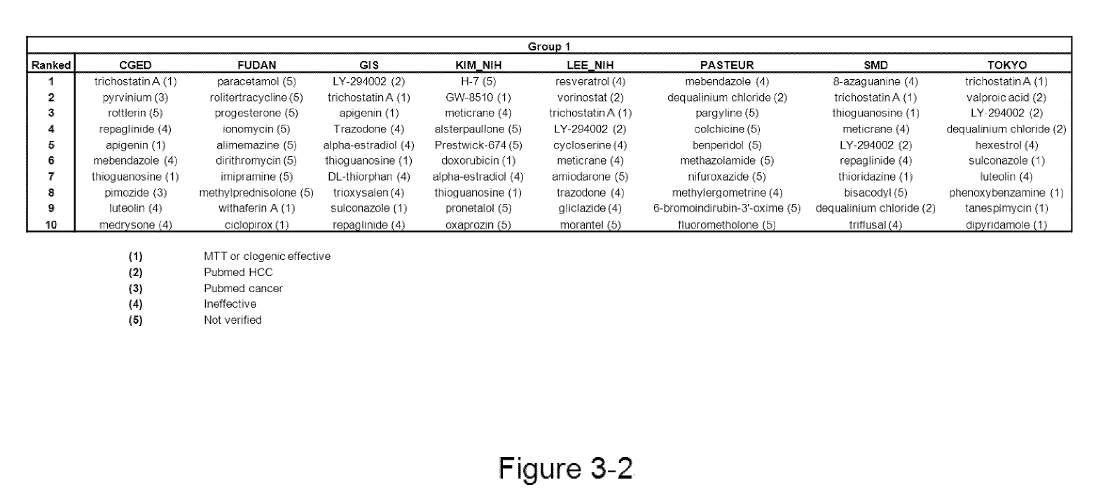

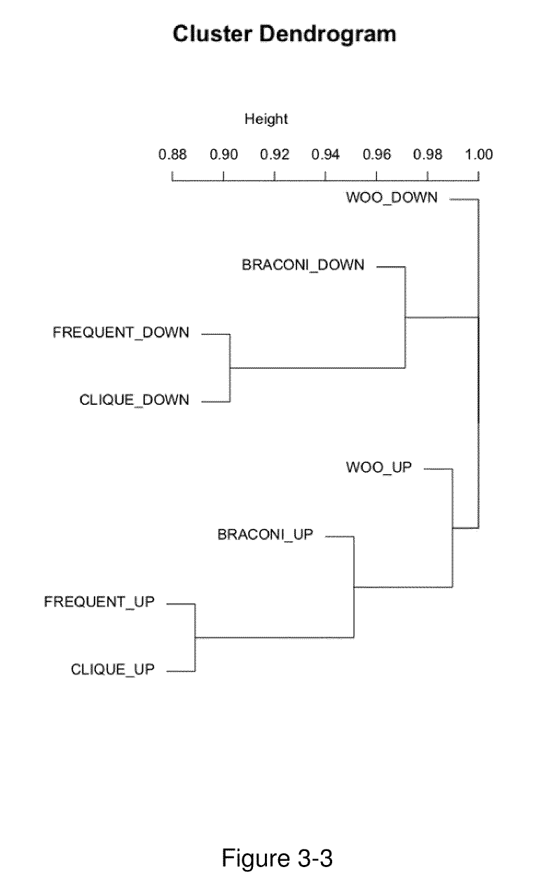

Two recent HCC gene expression datasets, BRACONI¹⁸, and WOO¹⁹, were not in the EHCO2 collections and referred to as Reference sets. The gene signatures were compared using Jaccard's Index (FIG. 2-3) with those in Group 1. Since the sets in Group 2 were derived from EHCO2, they obviously had more similarity than with the sets in Group 3. It should be noted that the down-regulated genes from WOO have no genes in common with the other sets, again arguing against using single study as the sole query genes for CMap analysis.

CMap Analysis of Group 2 and 3 Sets (Derived EHCO2 Sets and Reference Sets)

Group 2 and 3 containing seven different HCC gene sets, including three “100-random sets”, the “Frequent Set”, the “Clique Set”, and the Reference sets, were queried with CMap, and corresponding prioritized drug lists were generated (Table 2-3).

TABLE 2-3
A comparison of drug efficacy between Group 2 and Group 3.
Group 2

| | 100 Random | | 100 Random | | 100 Random | | | |
|---|---|---|---|---|---|---|---|---|
| Ranked | (250/250) | Count | (500/500) | Count | (1000/1000) | Count | Frequent Set | Clique Set |
| 1 | 8-azaguanine (4) | 96 | medrysone (4) | 99 | phenoxybenzamine | 100 | MS-275 (2) | LY-294002 (2) |
| | | | | | (1) | | | |
| 2 | medrysone (4) | 96 | trichostatin A (1) | 97 | apigenin (1) | 100 | vorinostat (2) | apigenin (1) |
| 3 | thioguanosine (1) | 91 | resveratrol (4) | 97 | Alpha-estradiol (4) | 100 | trichostatin A (1) | thioguanosine (1) |
| 4 | trichostatin A (1) | 90 | thioguanosine (1) | 94 | hexestrol (4) | 100 | repaglinide (4) | sulconazole (1) |
| 5 | phenoxybenzamine | 89 | hexestrol (4) | 93 | chlorpromazine (1) | 100 | thioguanosine (1) | luteolin (4) |
| | (1) | | | | | | | |
| 6 | Alpha-estradiol (4) | 83 | chlorpromazine (1) | 92 | resveratrol (4) | 100 | apigenin (1) | medrysone (4) |
| 7 | chlorpromazine (1) | 83 | 8-azaguanine (4) | 92 | thioguanosine (1) | 100 | LY-294002 (2) | trifluoperazine (1) |
| 8 | apigenin (1) | 81 | Alpha-estradiol (4) | 92 | MS-275 (2) | 100 | phenoxybenzamine | chlorpromazine (1) |
| | | | | | | | (1) | |
| 9 | levonorgestrel (3) | 80 | phenoxybenzamine | 90 | medrysone (4) | 100 | colforsin (5) | phenoxybenzamine |
| | | | (1) | | | | | (1) |
| 10 | resveratrol (4) | 80 | apigenin (1) | 88 | trichostatin A (1) | 100 | resveratrol (4) | thioridazine (1) |

Group 3

| Ranked | BRACONI | WOO |
|---|---|---|
| 1 | phenoxybenzamine (1) | LY-294002 (2) |
| 2 | tanespimycin (1) | 5224221 (5) |
| 3 | trichostatin A (1) | ifenprodil (3) |
| 4 | pyrvinium (3) | meptazinol (5) |
| 5 | apigenin (1) | arachidonic acid (5) |
| 6 | chlorpromazine (1) | (-)-atenolol (5) |
| 7 | luteolin (4) | methylergometrine (4) |
| 8 | omeprazole (5) | galantamine (5) |
| 9 | sulconazole (1) | estriol (5) |
| 10 | riboflavin (5) | cloperastine (4) |

(1) MTT or clonogenic effective
(2) Pubmed HCC
(3) Pubmed cancer
(4) Ineffective
(5) Not verified

The top three drugs with negative enrichment scores selected by the “Frequent Set” were MS-275, vorinostat, and trichostatin A. All three of these drugs are histone deacetylase inhibitors. The drugs selected by the “Clique Set” were LY-294002, apigenin, and thioguanosine. Apigenin inhibited the growth of Huh7 cells, and thioguanosine was able to reduce to cell viability in HCC cell lines (FIG. 2-3C). The top 3 drugs in the “100-random” sets were medrysone, 8-Azaguanine, and trichostatin A. However, neither medrysone nor 8-azaquanine could reduce cancer cell viability or inhibit cancer cell growth. The top three drugs from BRACONI were phenoxybenzamine, tanespimycin, and trichostatin A. Phenoxybenzamine, an alpha blocker, could inhibit the survival of Huh7 cells (Table 2-2). The top drug selected from WOO was LY-294002, which was as also selected using the “Clique Set”.

Using selected HCC gene signatures to reveal potential drugs with anti-proliferative or cytotoxic effects from CMap

Bioactive small molecules in CMap that reverse, at least in part, the HCC gene signatures may be the drugs with the potential to eradicate HCC cells. In fact, several drugs already have references linked to cancer, thus excluded from additional experimental validation. Drugs such as pyrvinium and levonorgestrel have PubMed references relating to cancers, while MS-275 and LY-294002 are known to specifically fight HCC. These drugs were marked as “PubMed Cancer” and “PubMed hepatocellular carcinoma or HCC”, respectively (Table 2-3). Additionally, we selected the 64 top-occurrence small molecules (Supplementary Table 2-3) from each of the 3 groups (a total prediction of 277 drugs) and determined the effects of these drugs on the cell proliferation of 4 HCC cell lines by the MTT and clonogenic assays. The drug with IC₅₀ (concentration that inhibits cell growth by 50%) less than 10 μM was defined as effective in the HCC cell lines. As shown in Table 2 and FIG. 3, the viability of HCC cell lines was reduced by more than 50% after co-incubation with various concentrations of trichostatin A and tanespimycin, for 72 hours (the IC₅₀s were less than 10 μM). These results were consistent with previous studies.^{18,23-25} Drugs with IC₅₀ over 10 μM (Table 2-2), were subjected to the clonogenic assay as a secondary screening. In short, as shown in Table 2-2, 10 out of the 16 top-ranked drugs were considered effective, whereas 2 out of the 6 ineffective drugs showed cytotoxicity at higher dosages than in other reports. For example, luteolin inhibited the proliferation of Huh-7 cells by producing intracellular reactive oxygen species, and its IC₅₀ was nearly 50 μM.

Accuracy of Drug Prediction Comparison

The effectiveness of the top 10 drugs from each set is depicted in FIG. 2-4. With the exception of the TOKYO and BRACONI sets, all other Group 1 and Group 3 sets had less than 50% prediction accuracy, suggesting that no single study of a heterogeneous disease can be used for CMap analysis. The Group 2 sets overall had better prediction results. While the “100-random” sets had a ˜50%-60% accuracy, the failure to preserve the gene correlation during randomization steps might reduce the power of this method. The FREQUENT and CLIQUE sets, on the other hand, maintained the most frequently occurring and the most clustered genes, resulting in better prediction power, 70% and 80% respectively.

### Example 3

Collection of HCC-related Gene Expression Signatures

As shown in FIGS. 3-1, 3-2 and 3-3, we maintained and updated the eight original datasets in the first version of EHCO. Some of the gene symbols and identifiers were corrected using the Gene Name Service. Some of the genes were excluded because they were discontinued from NCBI. PubMed, TableX_mRNA, and TableX_protein datasets were also updated with new genes. Briefly, for the PubMed dataset, we have extracted 1,084 genes (with gene names approved by HUGO Gene Nomenclature Committee) from approximately 4,500 abstracts in the PubMed category. Moreover, seven additional reports were manually added into the TableX_mRNA dataset. Similarly, four extra proteomics reports were included in the TableX_protein dataset. Among the HCC-related studies, EHCO2 further included six additional gene sets:

UCSF used cDNA microarrays containing 17,000 unique human genes to analyze the gene expression profiles of 102 primary HCC and 74 non-tumor liver tissues. They identified 636 genes with official HUGO symbols that were highly expressed in HCC.

CGED analyzed the gene expression profiles of 100 samples randomly selected from 120 HCC tissues, 86 non-tumor adjacent normal tissues and 32 normal liver tissues by adaptor-tagged competitive PCR (ATAC-PCR). Differential expression in normal and tumor tissues was observed for 596 of the 3,072 genes identified.

FUDAN analyzed the gene expression profiles of hepatitis B virus-positive HCC through the generation of a large set of 5′-read expressed sequence tag (EST) clusters from HCC and non-cancerous liver samples by using cDNA microarrays. In addition, a commercial cDNA microarray was used for profiling gene expression. Taken together, these experiments identified 2,253 genes/ESTs with differential expression, resulting in a gene set of 493 genes with official HUGO symbols.

PASTEUR applied cDNA microarrays to analyze the expression profiles of 15 cases of HCC. Genes with a ratio greater than or equal to 2 or a ratio less than 0.5 between tumor and non-tumor intensity were defined as up- or down-regulated, respectively. 84 genes with official HUGO symbols were defined in more than 30% of 30 comparisons of tumors versus non-tumors.

TOKYO¹⁸ analyzed the gene expression patterns of 20 primary HCCs and their corresponding non-cancerous tissues by using a cDNA microarray consisting of 23,404 genes. When a signal intensity cutoff ratio of 2.0 (cancer versus non-cancer) was applied, 165 genes (including 69 ESTs) were up-regulated in 75% or more of the HCC samples examined. On the other hand, 170 genes (including 75 ESTs) were down-regulated in 65% or more of the case examined when a cutoff intensity ratio of 0.5 was applied. Together, 242 genes have official HUGO symbols.

POFG used a computational method to identify 84 putative oncofetal genes (POFG) whose splicing pattern distribution is similar in fetal and tumorous adult tissues but different from or below detectable levels in normal adult tissue.

Confident EHCO2 Gene Set

The integration of these data resulted in disagreement among different datasets, therefore, we selected 3,298 HCC-related genes (1,821 up-regulated and 1,477 down-regulated) as our confident set from the 4,020 HCC-related genes from EHCO2. The confident set consists of genes that can be distinguished by their expression as up-regulated or down-regulated in at least two-thirds of the datasets in which the gene is present. Those genes present in only one dataset are also included in the confident set.

Generation of HCC Test Sets

a) Generation of Group 1: Original EHCO2 sets

The Group 1 contains the original 8 sets of microarray-based HCC gene expression profiles from EHCO2. The other 5 sets contain no microarray information and, thus, were excluded from further analysis. The UCSF and POFG sets were discarded since they only contained up-regulated genes. The SMD set, in which the number of differentially expressed probe sets exceeded CMap's limit of 1,000 probe sets, was filtered using the STITCH database such that all genes had known interacting proteins.

b) Generation of Group 2: Derived EHCO2 Sets

The Group 2 datasets were derived from the Group 1 data. The set, “100 random sets,” was generated to reflect a whole variety of HCC conditions, using a randomization technique to simulate possible combinations. The Confident Set was used as the pool for the randomization. Only genes with an annotation for the Affymetrix U133A platform were retained, resulting in a smaller set of 1,588 up-regulated and 1,308 down-regulated genes. The set consisted of 100 sets of 250 randomly selected up-regulated genes and 250 randomly selected down-regulated genes. Since the ratio of the number of probe sets to their corresponding genes was less than two, probe sets corresponding to the selected 500 genes would not exceed the CMap input limit of 1,000 probe sets. The randomly selected genes were converted into the probe IDs of the Affymetrix U133A platform by using the R packages from BioConductor. In addition, to be able to closely represent the complete HCC conditions, sets using 500 up-regulated and 500 down-regulated genes and 1,000 up-regulated and 1,000 down-regulated genes were generated. A program written in Ruby implemented the CMap core algorithms for inputs with more than 1,000 probe sets. This program was used to conduct the studies for the latter two random sets.

Furthermore, two sets were generated to enrich the HCC gene expression profile. The “Frequent Set” was created by selecting genes with more than 3 occurrences in EHCO2. This criterion extracted the more common HCC genes for further testing. In addition, to further enrich the gene set, Clique Analysis was employed. The term clique, originating from Graph Theory, describes nodes of a sub-graph that have connections to all the other nodes in that sub-graph. For example, a 3-clique is a graph with 3 interconnected nodes, which is also a triangle. The genes were used to construct their Protein-Protein Interactions (PPI) network, from which we were able to make calculations to select proteins with complete interactions. The last set “Clique Set” was created using this technique to formulate groups of four genes with interconnected PPI among them.

c) Generation of Group 3: Reference Sets

Two recent HCC papers utilized CMap for analysis. The gene signatures from each study were converted into probe IDs for the Affymetrix U133A platform by using the R packages from BioConductor and individually used to query CMap. Only drugs with p-values of less than 0.5 and negative enrichment scores were selected.

Complete materials and assay results for 64 drugs were shown in Table 3-1.

TABLE 3-1
Complete materials and assay results for 64 drugs.

| | | Catalog | IC50 | Clonogenic |
|---|---|---|---|---|
| Drug Name | Vendor | no. | (μM) | assay* |
| tanespimycin | Sigma | A8476 | <0.1 | N/A |
| alexidine | Prestwick | 777 | 0.1~1 | N/A |
| camptothecin | Prestwick | 200 | 0.1~1 | N/A |
| ellipticine | Prestwick | 614 | 0.1~1 | N/A |
| emetine | Prestwick | 570 | 0.1~1 | N/A |
| mitoxantrone | Prestwick | 385 | 0.1~1 | N/A |
| pyrvinium | Prestwick | 1040 | 0.1~1 | N/A |
| rotenone | Sigma | R8875 | 0.1~1 | N/A |
| sanguinarine | Prestwick | 987 | 0.1~1 | N/A |
| trichostatin A | Sigma | T8552 | 0.1~1 | N/A |
| withaferin A | Sigma | W4394 | 0.1~1 | N/A |
| astemizole | Prestwick | 136 | 1~5 | N/A |
| mefloquine | Prestwick | 126 | 1~5 | N/A |
| piperlongumine | Prestwick | 604 | 1~5 | N/A |
| thiostrepton | Prestwick | 522 | 1~5 | N/A |
| chlorpromazine | Sigma | C8138 | 5~10 | Effective |
| spiperone | Sigma | S7395 | 5~10 | Effective |
| sulconazole | Sigma | S9632 | 5~10 | Effective |
| bepridil | Prestwick | 368 | 5~10 | N/A |
| ciclopirox | Prestwick | 541 | 5~10 | N/A |
| clioquinol | Prestwick | 886 | 5~10 | N/A |
| GW-8510 | Sigma | G7791 | 5~10 | N/A |
| prochlorperazine | Sigma | P9178 | 5~10 | N/A |
| thioguanosine | Prestwick | 347 | 5~10 | N/A |
| thioridazine | Sigma | T9025 | 5~10 | N/A |
| tyloxapol | Prestwick | 954 | 5~10 | N/A |
| apigenin | Fluka | 10798 | >10 | Effective |
| azacitidine | Prestwick | 866 | >10 | Effective |
| cloperastine | Prestwick | 793 | >10 | Effective |
| dipyridamole | Prestwick | 142 | >10 | Effective |
| luteolin | Prestwick | 870 | >10 | Effective |
| phenoxybenzamine | Prestwick | 944 | >10 | Effective |
| DO 897/99 | Prestwick | 559 | >10 | Effective |
| propafenone | Prestwick | 499 | >10 | Effective |
| skimmianine | Prestwick | 668 | >10 | Effective |
| trifluoperazine | Sigma | T8516 | >10 | Effective |
| trioxysalen | Prestwick | 709 | >10 | Effective |
| 8-azaguanine | Fluka | 11410 | >10 | Ineffective |
| cycloserine | Prestwick | 1086 | >10 | Ineffective |
| DL-thiorphan | Prestwick | 633 | >10 | Ineffective |
| gliclazide | Sigma | G2167 | >10 | Ineffective |
| hexestrol | Prestwick | 699 | >10 | Ineffective |
| levonorgestrel | Prestwick | 773 | >10 | Ineffective |
| methylergometrine | Prestwick | 374 | >10 | Ineffective |
| meticrane | Sigma | M6902 | >10 | Ineffective |
| phthalylsulfathiazole | Prestwick | 869 | >10 | Ineffective |
| leucomisine | Prestwick | 1084 | >10 | Ineffective |
| evoxine | Prestwick | 665 | >10 | Ineffective |
| triflusal | Prestwick | 528 | >10 | Ineffective |
| zimeldine | Prestwick | 92 | >10 | Ineffective |
| amiodarone | Prestwick | 409 | >10 | N/A |
| chrysin | Prestwick | 889 | >10 | N/A |
| diltiazem | Prestwick | 134 | >10 | N/A |
| estriol | Prestwick | 1096 | >10 | N/A |
| eucatropine | Prestwick | 794 | >10 | N/A |
| fenoprofen | Prestwick | 754 | >10 | N/A |
| ginkgolide A | Prestwick | 444 | >10 | N/A |
| ifenprodil | Prestwick | 311 | >10 | N/A |
| morantel | Prestwick | 61 | >10 | N/A |
| pargyline | Prestwick | 183 | >10 | N/A |
| procaine | Prestwick | 41 | >10 | N/A |
| ronidazole | Prestwick | 1115 | >10 | N/A |
| roxithromycin | Prestwick | 854 | >10 | N/A |
| sulfametoxydiazine | Prestwick | 769 | >10 | N/A |

*Effectiveness in clonogenic assay is defined as reducing more than 50% colony number at 10 μM

Braconi et al. compared 81 human samples and generated a 73-gene signature associated with vascular invasion. Finally, Woo et al. correlated the CNV (Copy Number Variation) of 15 HCC samples with the gene expression profiles of 139 samples and discovered 50-gene signatures as potential driver genes. The gene signatures were stratified by the signs associated with their mRNA expression, with positive values as up-regulation and negative values as down-regulation.

Calculation of a Similarity Matrix

To compare the similarity of the gene list between any pair of sets, Jaccard's index was applied. The index between two lists is defined as the ratio of the number of intersecting items to the number of union items, or mathematically, Jaccard(A,B)=(A and B)/(A or B). Jaccard's distance, or the dissimilarity, is defined as 1-Jaccard. Jaccard's distance matrix was used to perform hierarchical clustering using R.

It is believed that a person of ordinary knowledge in the art where the present invention belongs can utilize the present invention to its broadest scope based on the descriptions herein with no need of further illustration. Therefore, the descriptions and claims as provided should be understood as of demonstrative purpose instead of limitative in any way to the scope of the present invention.

### REFERENCES

1. Tao Q, Chan A T. Nasopharyngeal carcinoma: molecular pathogenesis and therapeutic developments. Expert Rev Mol Med 2007; 9:1-24.
2. Lee Y C, Hwang Y C, Chen K C, et al. Effect of Epstein-Ban virus infection on global gene expression in nasopharyngeal carcinoma. Funct Integr Genomics 2007; 7:79-93.
3. Chen X, Liang S, Zheng W, Liao Z, Shang T, Ma W. Meta-analysis of nasopharyngeal carcinoma microarray data explores mechanism of EBV-regulated neoplastic transformation. BMC Genomics 2008; 9:322.
4. Sriuranpong V, Mutirangura A, Gillespie J W, et al. Global gene expression profile of nasopharyngeal carcinoma by laser capture microdissection and complementary DNA microarrays. Clin Cancer Res 2004; 10:4944-58.
5. Shi W, Bastianutto C, Li A, et al. Multiple dysregulated pathways in nasopharyngeal carcinoma revealed by gene expression profiling. Int J Cancer 2006; 119:2467-75.
6. Zeng Z Y, Zhou Y H, Zhang W L, et al. Gene expression profiling of nasopharyngeal carcinoma reveals the abnormally regulated Wnt signaling pathway. Hum Pathol; 38:120-33.
7. Fang W, Li X, Jiang Q, et al. Transcriptional patterns, biomarkers and pathways characterizing nasopharyngeal carcinoma of Southern China. J Transl Med 2008; 6:32.

8. Chang E T, Adami H O. The enigmatic epidemiology of nasopharyngeal carcinoma. Cancer Epidemiol Biomarkers Prey 2006; 15:1765-77.
9. Chou J, Lin Y C, Kim J, et al. Nasopharyngeal carcinoma—review of the molecular mechanisms of tumorigenesis. Head Neck 2008; 30:946-63.
10. Jeong H, Mason S P, Barabasi A L, Oltvai Z N. Lethality and centrality in protein networks. Nature 2001; 411:41-2.
11. Batada N N, Hurst L D, Tyers M. Evolutionary and physiological importance of hub proteins. PLoS Comput Biol 2006; 2:e88.
12. Lee S A, Chan C H, Chen T C, et al. POINeT: Protein Interactome with Sub-network Analysis and Hub Prioritization. BMC Bioinformatics 2009; 10:114.
13. Lamb J. The Connectivity Map: a new tool for biomedical research. Nat Rev Cancer 2007; 7:54-60.
14. Lamb J, Crawford E D, Peck D, et al. The Connectivity Map: using gene-expression signatures to connect small molecules, genes, and disease. Science 2006; 313:1929-35.
15. Wei G, Twomey D, Lamb J, et al. Gene expression-based chemical genomics identifies rapamycin as a modulator of MCL1 and glucocorticoid resistance. Cancer Cell 2006; 10:331-42.
16. De Preter K, De Brouwer S, Van Maerken T, et al. Meta-mining of neuroblastoma and neuroblast gene expression profiles reveals candidate therapeutic compounds. Clin Cancer Res 2009; 15:3690-6.
17. Ebi H, Tomida S, Takeuchi T, et al. Relationship of deregulated signaling converging onto mTOR with prognosis and classification of lung adenocarcinoma shown by two independent in silico analyses. Cancer Res 2009; 69:4027-35.
18. Hsu C N, Chang Y M, Kuo C J, Lin Y S, Huang H S, Chung I F. Integrating high dimensional bi-directional parsing models for gene mention tagging. Bioinformatics 2008; 24:1286-94.
19. Lin K T, Liu C H, Chiou J J, Tseng W H, Lin K L, Hsu C N. Gene Name Service: No-Nonsense Alias Resolution Service for Homo Sapiens Genes. Proceedings of the 2007 IEEE/WIC/ACM International Conference on Web Intelligence and Intelligent Agent Technology Workshops (WI-IAT Workshops 2007); 2007 Nov. 5; Silicon Valley. Washington, D.C.: IEEE; 2007.
20. Keshava Prasad T S, Goel R, Kandasamy K, et al. Human Protein Reference Database—2009 update. Nucleic Acids Res 2009; 37:D767-72.
21. Luc P V, Tempst P. PINdb: a database of nuclear protein complexes from human and yeast. Bioinformatics 2004; 20:1413-5.
22. Ruepp A, Brauner B, Dunger-Kaltenbach I, et al. CORUM: the comprehensive resource of mammalian protein complexes. Nucleic Acids Res 2008; 36:D646-50.
23. Kamburov A, Wierling C, Lehrach H, Herwig R. ConsensusPathDB—a database for integrating human functional interaction networks. Nucleic Acids Res 2009; 37:D623-8.
24. Huang da W, Sherman B T, Lempicki R A. Systematic and integrative analysis of large gene lists using DAVID bioinformatics resources. Nat Protoc 2009; 4:44-57.
25. Kuhn M, von Mering C, Campillos M, Jensen L J, Bork P. STITCH: interaction networks of chemicals and proteins. Nucleic Acids Res 2008; 36:D684-8.
26. Wishart D S, Knox C, Guo A C, et al. DrugBank: a knowledgebase for drugs, drug actions and drug targets. Nucleic Acids Res 2008; 36:D901-6.
27. Lin C T, Chan W Y, Chen W, et al. Characterization of seven newly established nasopharyngeal carcinoma cell lines. Lab Invest 1993; 68:716-27.
28. Liao S K, Perng Y P, Shen Y C, Chung P J, Chang Y S, Wang C H. Chromosomal abnormalities of a new nasopharyngeal carcinoma cell line (NPC-BM1) derived from a bone marrow metastatic lesion. Cancer Genet Cytogenet 1998; 103:52-8.
29. Chen T C, Lee S A, Chan C H, et al. Cliques in mitotic spindle network bring kinetochore-associated complexes to form dependence pathway. Proteomics 2009; 9:4048-62.
30. Spirin V, Mirny L A. Protein complexes and functional modules in molecular networks. Proc Natl Acad Sci USA 2003; 100:12123-8.
31. Frouin I, Montecucco A, Biamonti G, Hubscher U, Spadari S, Maga G. Cell cycle-dependent dynamic association of cyclin/Cdk complexes with human DNA replication proteins. EMBO J 2002; 21:2485-95.
32. Ellison V, Stillman B. Reconstitution of recombinant human replication factor C(RFC) and identification of an RFC subcomplex possessing DNA-dependent ATPase activity. J Biol Chem 1998; 273:5979-87.
33. Lee S H, Kwong A D, Pan Z Q, Hurwitz J. Studies on the activator 1 protein complex, an accessory factor for proliferating cell nuclear antigen-dependent DNA polymerase delta. J Biol Chem 1991; 266:594-602.
34. Uhlmann F, Cai J, Flores-Rozas H, et al. In vitro reconstitution of human replication factor C from its five subunits. Proc Natl Acad Sci USA 1996; 93:6521-6.
35. Wang Y, Cortez D, Yazdi P, Neff N, Elledge S J, Qin J. BASC, a super complex of BRCA1-associated proteins involved in the recognition and repair of aberrant DNA structures. Genes Dev 2000; 14:927-39.
36. Hayano T, Yanagida M, Yamauchi Y, Shinkawa T, Isobe T, Takahashi N. Proteomic analysis of human Nop56p-associated pre-ribosomal ribonucleoprotein complexes. Possible link between Nop56p and the nucleolar protein treacle responsible for Treacher Collins syndrome. J Biol Chem 2003; 278:34309-19.
37. Bouwmeester T, Bauch A, Ruffner H, et al. A physical and functional map of the human TNF-alpha/NF-kappa B signal transduction pathway. Nat Cell Biol 2004; 6:97-105.
38. Leong J L, Loh K S, Putti T C, Goh B C, Tan L K. Epidermal growth factor receptor in undifferentiated carcinoma of the nasopharynx. Laryngoscope 2004; 114:153-7.
39. Pan J, Kong L, Lin S, Chen G, Chen Q, Lu J J. The clinical significance of coexpression of cyclooxygenases-2, vascular endothelial growth factors, and epidermal growth factor receptor in nasopharyngeal carcinoma. Laryngoscope 2008; 118:1970-5.
40. Ma B B, Poon T C, To K F, et al. Prognostic significance of tumor angiogenesis, Ki 67, p53 oncoprotein, epidermal growth factor receptor and HER2 receptor protein expression in undifferentiated nasopharyngeal carcinoma—a prospective study. Head Neck 2003; 25:864-72.
41. Bar-Sela G, Kuten A, Ben-Eliezer S, Gov-Ari E, Ben-Izhak O. Expression of HER2 and C-KIT in nasopharyngeal carcinoma: implications for a new therapeutic approach. Mod Pathol 2003; 16:1035-40.
42. Yan J, Fang Y, Huang B J, Liang Q W, Wu Q L, Zeng Y X. Absence of evidence for HER2 amplification in nasopharyngeal carcinoma. Cancer Genet Cytogenet 2002; 132:116-9.
43. Bose S, Yap L F, Fung M, et al. The ATM tumour suppressor gene is down-regulated in EBV-associated nasopharyngeal carcinoma. J Pathol 2009; 217:345-52.
44. Weinberg R A. P53 and apoptosis: master guardian and executioner. In: Weinberg R A, editor. The biology of cancer. New York: Garland Science; 2007. P.307-56.
45. Li L, Guo L, Tao Y, et al. Latent membrane protein 1 of Epstein-Barr virus regulates p53 phosphorylation through MAP kinases. Cancer Lett 2007; 255:219-31.
46. Ogino T, Moriai S, Ishida Y, et al. Association of immunoescape mechanisms with Epstein-Barr virus infection in nasopharyngeal carcinoma. Int J Cancer 2007; 120:2401-10.
47. Ho S Y, Guo H R, Chen H H, Hsiao J R, Jin Y T, Tsai S T. Prognostic implications of Fas-ligand expression in nasopharyngeal carcinoma. Head Neck 2004; 26:977-83.
48. Reimand J, Kull M, Peterson H, Hansen J, Vilo J. g:Profiler—a web-based toolset for functional profiling of gene lists from large-scale experiments. Nucleic Acids Res 2007; 35:W193-200.
49. Gil-Ad I, Shtaif B, Levkovitz Y, et al. Phenothiazines induce apoptosis in a B16 mouse melanoma cell line and attenuate in vivo melanoma tumor growth. Oncol Rep 2006; 15:107-12.
50. Zhelev Z, Ohba H, Bakalova R, et al. Phenothiazines suppress proliferation and induce apoptosis in cultured leukemic cells without any influence on the viability of normal lymphocytes. Phenothiazines and leukemia. Cancer Chemother Pharmacol 2004; 53:267-75.

I/we claim:

1. A process for discovering potential treatment strategy for a given disease comprising the steps of:
(a) collecting up- and down-regulated genes of the given disease or cells from published microarray data and primary literatures to obtain initial gene signature;
(b) converting the initial gene signatures as collected in step (a) to form a protein-protein interaction (PPI) network;
(c) analyzing the PPI network topologically to obtain key regulators involved in the given disease, as referred to as bottleneck genes;
(d) defining one or more features of particular interests, and narrowing down the PPI network based on the defined features to retrieve the bottleneck genes for predicting the given disease;
(e) collecting additional genes involved in the protein complexes and genes in relation to the given disease after functional profiling, and merging them with the bottleneck genes as obtained in step (d) to obtain final gene signature of the up- and down-regulated genes; and
(f) querying a connectivity map using the initial and final NPC gene signatures respectively to discover potential treatment strategy for the given disease.

2. A process for discovering a potential therapeutic agent for the treatment of nasopharyngeal carcinoma (NPC), comprising the steps of:
(a) collecting up- and down-regulated NPC genes from published microarray data and primary literatures to obtain initial gene signature;
(b) converting the initial gene signature as collected in step (a) to form a protein-protein interaction (PPI) network;
(c) analyzing the PPI network topologically to obtain key regulators involved in tumorgenesis of NPC referred to as bottleneck genes;
(d) narrowing down the PPI network by pathway analysis to retrieve the bottleneck genes for predicting NPC carcinogenesis;
(e) collecting additional oncogenes, tumor suppressor genes, genes involved in protein complexes and genes in relation to NPC after functional profiling, and merging them with the bottleneck genes to form final gene signature of up- and down-regulated genes; and
(f) querying a connectivity map using the initial and final NPC gene signatures respectively to discover potential drugs for treating NPC.
